(19) United States
(12) Patent Application Publication
(10) Pub. No.: US 2026/0031990 A1
(43) Pub. Date: Jan. 29, 2026

(54) METHODS FOR USER-AWARE TRUSTWORTHY DIRECT SERVICE INTERACTION IN WIRELESS NETWORKS

(71) Applicant: InterDigital Patent Holdings, Inc., Wilmington, DE (US)

(72) Inventors: Chonggang Wang, Princeton, NJ (US); Xu Li, Plainsboro, NJ (US); Robert Gazda, Spring City, PA (US); Michael Starsinic, Newtown, PA (US); Samir Ferdi, Kirkland (CA); Ulises Olvera-Hernandez, Saint-Lazare (CA)

(73) Assignee: InterDigital Patent Holdings, Inc., Wilmington, DE (US)

(21) Appl. No.: 18/781,195

(22) Filed: Jul. 23, 2024

(51) Int. Cl. H04L 9/32

(52) U.S. Cl. CPC H04L 9/321; H04L 9/3234

(57) ABSTRACT

Procedures are directed to dynamical trust-based authentication for request/response service interaction. A service consumer with an associated user and device may send, to a service producer, a service operation request message requesting access to a target service. The service operation request message may include a first indication indicating that the user and the device will use a trust index of the service producer and a second indication indicating that the user and the device support authentication using a user trust index of the user and/or a device trust index of the device. The service consumer may receive, from the service producer, an authentication notification message including an indication of a trust-based authentication result, and may respond with an authentication confirmation message. The service consumer may receive, from the service producer, a service operation response message including a service execution result associated with the executed target service.

### SUMMARY

Procedures are directed to dynamical trust-based authentication for request/response service interaction. In an example, a service consumer with an associated user and device may send, to a service producer, a service operation request message requesting access to at least one target service at the service producer. The service operation request message may include a first indication indicating that the user and the device will authenticate and authorize the service producer using a trust index of the service producer and a second indication indicating that the user and the device support or request to be authenticated and authorized by the service producer using at least one of: a user trust index (UTI) of the user and a device trust index (DTI) of the device. The service consumer may receive, from the service producer, an authentication notification message including an indication of a trust-based authentication result. The service consumer may send, to the service producer, an authentication confirmation message. The service consumer may receive, from the service producer, a service operation response message including at least one service execution result associated with the executed at least one target service.

In another example, a service producer may receive, from a service consumer, a service operation request message requesting access to at least one target service provided by the service producer. The service operation request message may include a first indication indicating that a user associated with the service consumer and a device associated with the service consumer will authenticate and authorize the service producer using a trust index of the service producer and a second indication indicating that the user and the device support or request to be authenticated and authorized by the service producer using at least one of: a user trust index (UTI) of the user and a device trust index (DTI) of the device. The service producer may determine that a trust level authentication of the user associated with the service consumer or a device associated with the service consumer is needed. The service producer may select and authenticate a trust management function (TMF). The service producer may send, to the selected and authenticated TMF, a request message requesting at least one of the UTI of the user and the DTI of the device. The service producer may receive, from the selected and authenticated TMF, a response message including an indication of at least one of the UTI of the user and the DTI of the device. The service producer may authenticate the received service operation request message using trust-based authentication based on the at least one of the UTI of the user and the DTI of the device. The service producer may send, to the service consumer, an authentication notification message including an indication of a result of the trust-based authentication indicating that the service producer will execute the at least one target service. The service producer may receive, from the service consumer, an authentication confirmation message. The service producer may execute the at least one target service. The service producer may send, to the service consumer, a service operation response message including at least one service execution result associated with the executed at least one target service.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a system diagram illustrating example security domains within an example communications system;

FIG. 3 is a system diagram illustrating three examples of dynamic service access from a user in an example communications system;

FIG. 4 is a signaling diagram illustrating an example procedure for dynamic trust-based authentication for request/response-based service interaction;

FIG. 5 is a signaling diagram illustrating an example procedure for dynamical trust-based authentication for request/response service interaction where a FESP retrieves a trust index;

FIG. 6 is a signaling diagram illustrating an example procedure for dynamical trust-based authentication for request/response service interaction where a TMF forwards a trust index to a FESP;

FIG. 7 is a signaling diagram illustrating an example procedure for dynamical trust-based authentication for request/response service interaction where a FESC provides a trust index to a FESP;

FIG. 8 is a signaling diagram illustrating an example procedure for dynamic trust-based authentication for request/response service interaction; and

FIG. 9 is a signaling diagram illustrating an example procedure for PDL Service Interactions based on Dynamic Trust-based Authentication.

### DETAILED DESCRIPTION

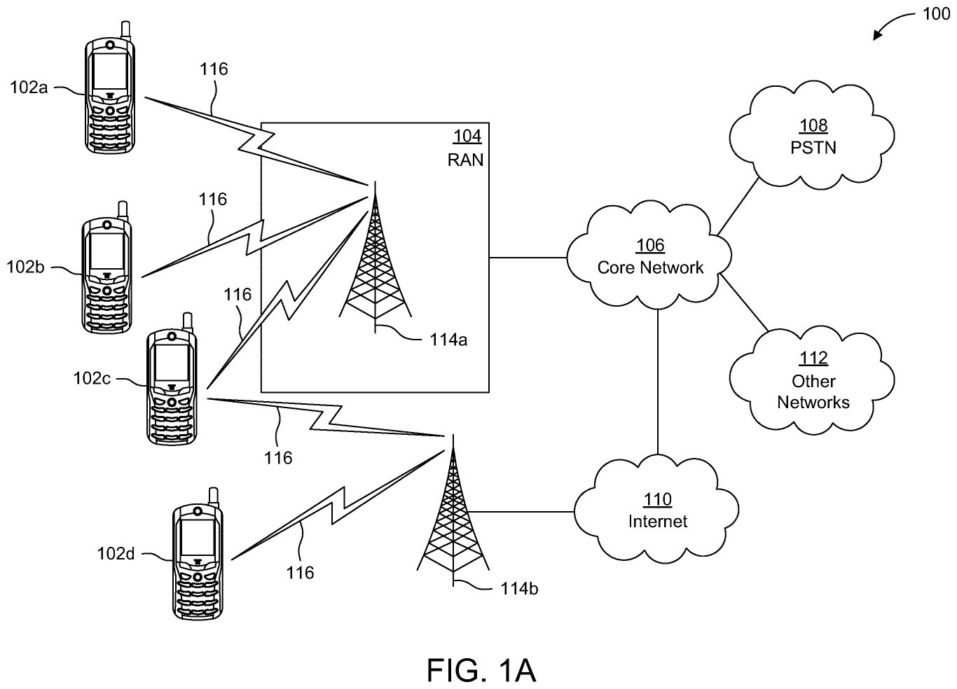

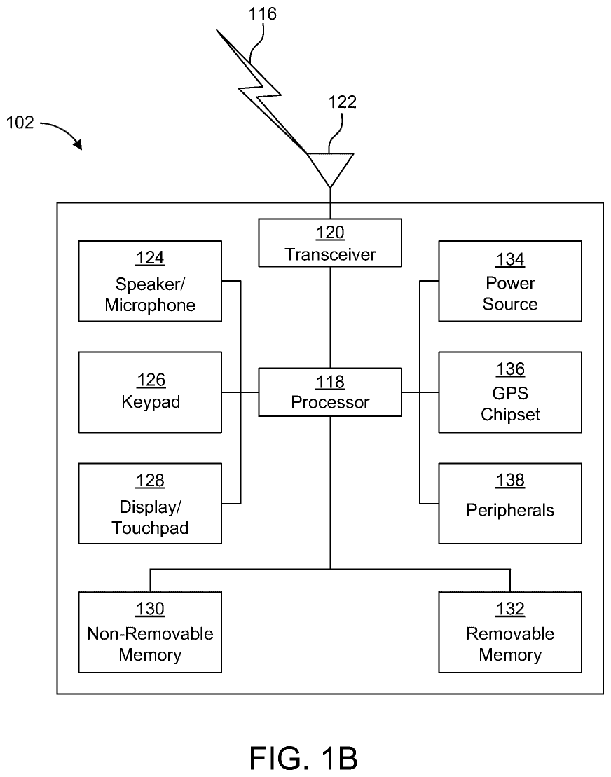

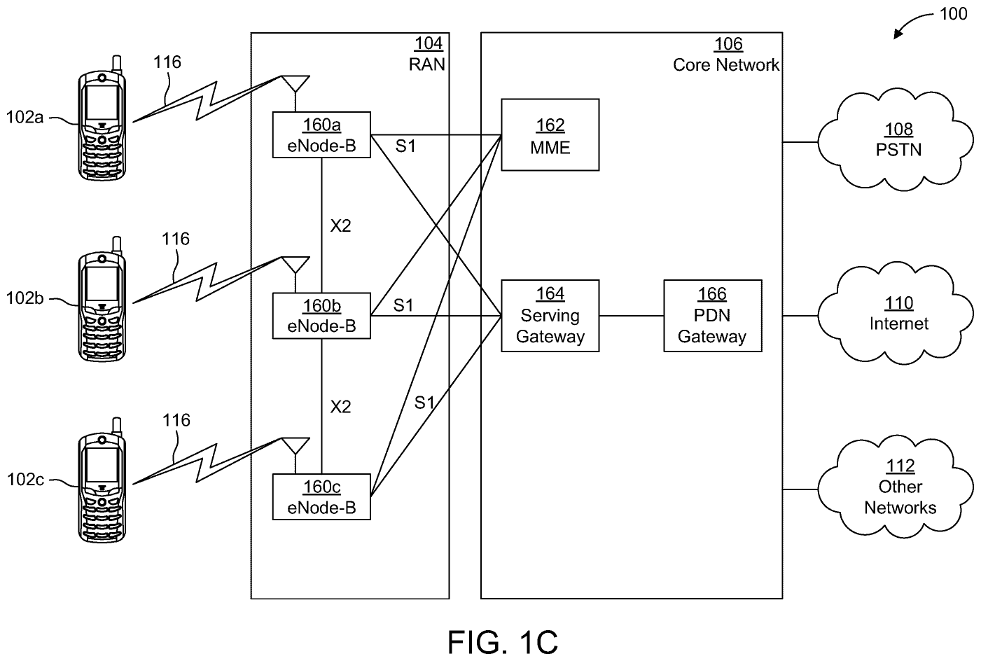

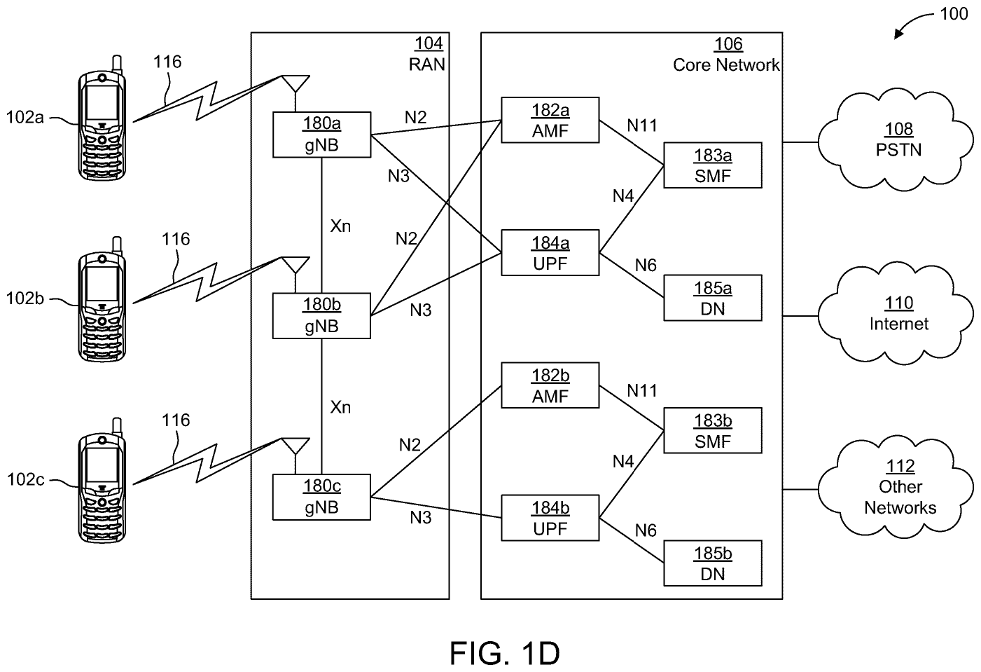

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHZ, and 20 MHz bandwidths in the TV White Space (TVWS) spectrum, and 802.11ah supports 1 MHZ, 2 MHz, 4 MHZ, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHZ. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

An existing 3rd Generation Partnership Project (3GPP) Fifth Generation System (5GS) may have limitations in supporting dynamic service access from a user, and in determining trust of the service consumer and/or service producer. For example, a 5GS may not consider dynamic user context for trust establishment and may not support, at least in part, dynamic user authentication. A 5GS may not support dynamic user authentication based on the user's trust index or the trust index of a service producer.

Technical issues addressed herein include how to support dynamic user authentication leveraging user trust so that service access in wireless systems will be user-aware and trustworthy. In scenarios where dynamic user authentication does not take into account user trust, the wireless system may authenticate a user once, resulting in the user having access to network services for an extended period of time, even when the user context changes and results in degraded user trust index. This can lead to the wireless system being less secure and more vulnerable to potential user attacks.

In an example, existing request/response-based direct service interaction under dynamic service access scenarios may not be trustworthy. In existing 5G request/response-based direct service interaction, a network function (NF) service consumer may acquire an access token from a network repository function (NRF) and present the access token to a NF service producer when issuing service requests. Then, the NF service producer may authenticate and authorize the NF service consumer according to the access token. However, an authorized access token does not guarantee trustworthy service interactions because the trust index of both the NF service consumer and the NF service producer may be highly dynamic and may change under various conditions.

To address the issues described above, solutions using request/response-based direct service interaction with dynamic trust-based authentication are disclosed herein. In an example, a Function Entity Service Consumer (FESC), or more generally a service consumer or consumer, may directly send a request for accessing a target service to a Function Entity Service Producer (FESP), or more generally a service producer or producer. The FESP may retrieve the trust index of the FESC from a Trust Management Function (TMF). The FESP may use the trust index of the FESC to perform Dynamic Trust-based Authentication (DTA) over the request received from the FESC. The FESP may send an authentication notification to the FESC, and the authentication notification may contain the trust-based authentication result. If the FESC is allowed to request the target service according to the trust-based authentication, the FESP may execute the target service for the FESC. When the execution of the target service is completed, the FESP may collect service results, include the service results in a response, and send the response to the FESC. In an example approach, the FESP may retrieve the trust index from a TMF. In another example approach, the TMF may forwards the trust index to the FESP. In another example approach, the FESC may provide the trust index. As used herein, a trust index may be a metric that indicates a level of trustworthiness and is based on a trust evaluation of one or more trust indicators. The trust indicators may include, for example, factors related to any one or more of: security, privacy, resilience, performance, robustness, scalability, availability, accuracy, reliability, or consistency. Examples of trust indexes include a trust index of a device (e.g., device trust index (DTI)), a trust index of a user (e.g., user trust index (DTI), and a trust index of a service producer.

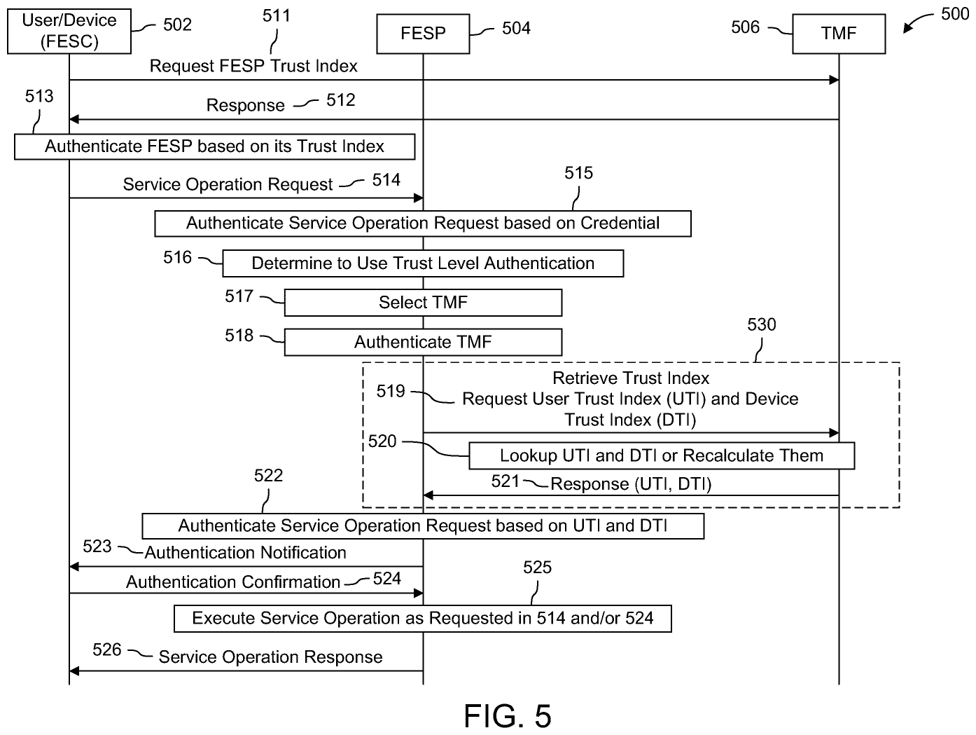

According to an example procedure for dynamical trust-based authentication for request/response service interaction, the FESP may retrieve the trust index from the TMF. A user/device/WTRU may send a first request to a second node (e.g., a TMF) to retrieve the trust index of a third node (e.g., FESP). The user/device/WTRU may receive a first response from the second node containing the first trust index of the third node. The user/device/WTRU may authenticate the third node based on the first trust index. The user/device/WTRU may generate a second request for accessing a service from the third node. The second request may contain any one or more of the following: the identifier of the first node; the identifier of the second node; and/or the identifier or the name of requested services. The user/device/WTRU may send the second request to the third node. The user/device/WTRU may receive an authentication notification from the third node indicating the authentication results of the second request. The user/device/WTRU may check and accept the authentication results about the requested services. The user/device/WTRU may send an authentication confirmation to the third node indicating the acceptance of the authentication results. The user/device/WTRU receive a second response from the third node indicating the execution results of requested services/This example procedure is described in more detail below with respect to FIG. 5.

In embodiments and examples provided herein, the terms user, device, WTRU, FESC, service consumer and consumer may be used interchangeably. Also, terms FESP, service producer, and producer may be used interchangeably in embodiments and examples provided herein. Each of a FESC and a FESP may be a WTRU (e.g., WTRU) or an infrastructure node such as a base station or Node B. Any of the FESC, the FESP, and/or the TMF may exist at separate locations and/or on separate nodes or devices, and/or may be co-located on a common node or device.

5G system architecture may consist of User Equipment (UE) (also referred to as WTRU), Radio Access Network (RAN), and Core Network (CN). One of the design principles for the 5G System (5GS) is service-centric or service-based. 5G Core Network (5GC) may follow a Service-Based Architecture (SBA) and may contain a variety of Network Functions (NFs), which work together to fulfill and provide needed services to the RAN, WTRUs, and Application Servers/Service Providers. The WTRU may interact with the RAN/5GC via Non-Access Statum (NAS) and Access Stratum (AS) signaling.

An NF may access other network functions in request/response mode or subscription/notification mode. Before two NFs interact with each other, they may first register with a Network Repository Function (NRF) so that they can discover each other via the NRF. Among these network functions, Access and Mobility Management Function (AMF) may manage a WTRU's access to 5GS and the WTRU's mobility, Session Management Function (SMF) may be responsible for establishing sessions between a WTRU and 5GC, and Authentication Server Function (AUSF) may handle WTRU authentication. In addition, Policy Control Function (PCF) may provide policy rules for other control plane network functions and WTRUs. PCF may assign an identifier for each created policy rule, which other control plane network functions and WTRUs use to refer to the corresponding policy rule. User Plane Function (UPF) is a core network function in the data plane that facilitates monitoring, managing, controlling, and redirecting user plane traffic flows such as between a WTRU and an Application Function (AF). Network Exposure Function (NEF) may enable access to 5G control plane functions to entities such as network applications and AFs, which may be outside of the 5GS and not in the same trusted domain.

Two NFs (e.g., a service consumer and a service producer) may communicate with each other directly without any entity in the middle or may communicate indirectly, such as via Service Communication Proxy (SCP) or other entity. A SCP may be responsible for forwarding and routing messages between a NF service consumer and a NF service producer. In addition, two NFs may interact with each other using request/response mode or subscribe/notify model. According to a request/response model, a NF service consumer may send a request to a NF service producer. The NF service producer may process the request and send a response to the NF service consumer. According to a subscribe/notify model, a NF service consumer may first send a subscription request to a NF service producer. The NF service producer may process the subscription request and store the subscription information. In this case, whenever any subscribed event occurs, the NF service producer may send a notification to the NF service consumer.

5GC may also provide data storage and analytics services through functions such as Unified Data Management (UDM), Unified Data Repository (UDR), Unstructured Data Storage Function (UDSF) and/or Network Data Analytics Function (NWDAF). Another critical feature of 5GS is network slicing, which may be facilitated by Network Slice Selection Function (NSSF).

5GS may include network functions such as Location Management Function (LMF) to support location services. LMF may be responsible for calculating, determining, and/or verifying a final location and any velocity estimation and may estimate the achieved accuracy, based on location information from the target WTRU and/or a RAN node. After LMF calculates the location of a target WTRU, other entities may access or query its own location from LMF, which may be through a serving AMF.

Although the examples network functions described herein may be defined as separate logical entities, a particular service scenario may require multiple network functions. For example, WTRU mobility may use one or more of AMF, AUSF and SMF. For a type of network function, multiple instances may be instantiated and NRF may maintain the information of each instantiated network function instance. With the emergence of edge computing, some network functions in 5GC, such as UPF and NEF, may be deployed and may reside in an edge network that is much nearer to and/or potentially co-located with the RAN.

Although the solutions, entities and network functions described herein may be described with respect to 5GS, the solutions, entities and network functions may be used in other communications systems including future 3GPP systems (e.g., 6G systems), and existing or future non-3GPP communication system.

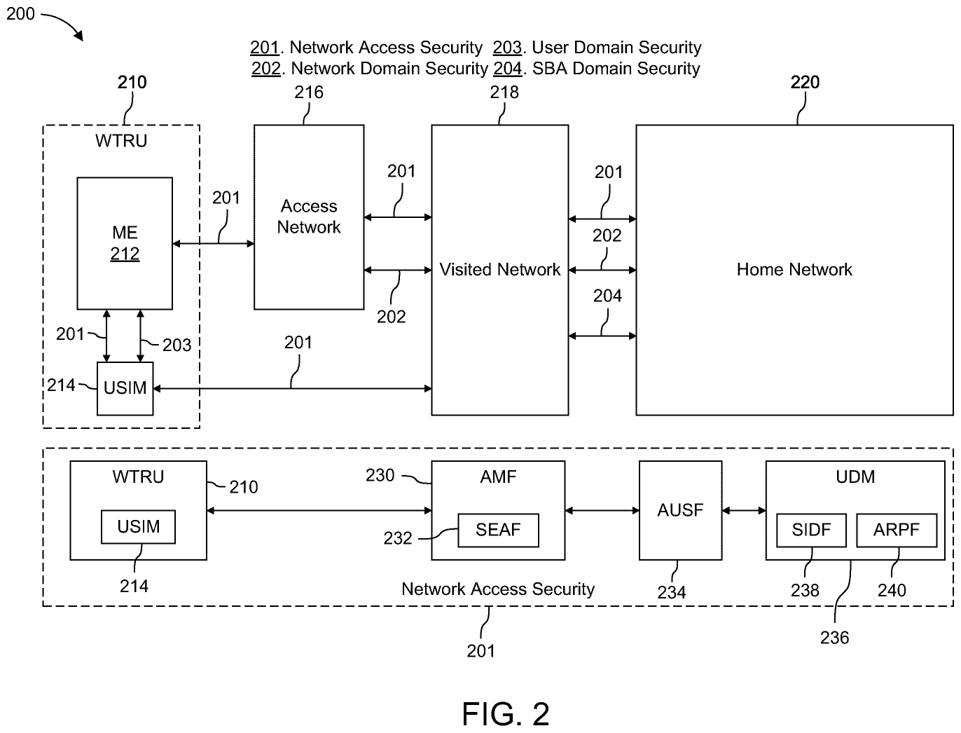

FIG. 2 is a system diagram illustrating example security domains 201-204 within an example communication system 200. With reference to FIG. 2, 5G security functions may cover any of the following security domains within a 5G system: security for network access between WTRU and RAN/5GC (201); network domain security between RAN and 5GC (202); user domain security between Mobile Equipment (ME) and Universal Subscriber Identity Module (USIM) (203); and SBA domain security in 5GC (204). The communication system 200 may be 5GS and may include: WTRU 210, Access Network 216, Visited Network 218, and Home Network 220. Network access security may be performed by AMF 230, Authentication Server Function (AUSF) 235, and/or Unified Data Management (UDM) function 236. The UDM function 236 may include Subscriber Identity De-concealing Function (SIDF) 238 and/or Authentication credential Repository and Processing Function (ARPF) 240. Any of AMF 230, AUSF 234, and/or UDM 236 may reside, for example, in the home network 220.

5G network access security 201 may be realized mainly through network access authentication, message encryption, and message integrity protection. Network access authentication may include primary authentication and key agreement, and secondary authentication. The primary authentication and key agreement may be designed to enable any of the following: mutual authentication between WTRU 210 and a home network 220; and agreed keying material (e.g., an anchor key KSEAF to be used by Security Anchor Function (SEAF) 232 in AMF 230) at both network side 220 and WTRU side 210. The basis behind 5G primary authentication and key agreement is that the same long-term key K unique to a WTRU 210 may be securely maintained at USIM 214 in the WTRU 210 and in the home network 220, based on the anchor key KSEAF and other key materials (e.g., keys for encryption and integrity protection for NAS and AS signaling). The same long-term key K may independently and identically be derived at the WTRU 210 and at the home network 220, without exchanging the key over the air. Mutual authentication may be established when the WTRU 210 and the home network 220 prove to each other that they know the same long-term key K. Since the primary authentication is solely based on the long-term key K, it may not consider user-centric aspects (e.g., user behaviors) and may not authenticate/differentiate users from the same or different WTRUs.

In an example, secondary authentication may be designed as an option to provide security between a WTRU and external Data Network (DN) as a part of session management. The secondary authentication may rely on SMF to initiate and coordinate the authentication procedure between WTRU and DN (e.g., a DN-AAA Server).

In an example, a blockchain system may be any of the following: a permission-less blockchain system (e.g., Bitcoin, Ethereum) where any party or user can use and participate in the blockchain system without pre-granted permissions; or a permissioned blockchain system where access to the blockchain system needs to be permissioned, controlled and/or governed. Permissioned Distributed Ledgers (PDL), as defined for example by European Telecommunications Standards Institute (ETSI) Industry Specification Group (ISG) on PDL, is an example of permissioned blockchain systems. ETSI ISG on PDL publishes Group Reports (GR) and Group Specifications (GS) on various topics such as PDL reference architecture, use cases, specific PDL functionalities, and vertical domains. Example ETSI GR describe use cases where PDL can be leveraged and integrated with 3GPP systems such as 5GS. Example ETSI GSs develop standards for provisioning PDL services within 3GPP system, including the following functions: Distributed Ledger Anchor Function (DLAF), Distributed Ledger Repository Function (DLRF), and Distributed Ledger Enabler (DLE). DLAF and DLRF may be control plane functions for the 3GPP system, and DLE may be a data plane function. Example ETSI GSs may aim to specify technical requirements and solutions based on PDL to build a native Self-Sovereign Identity (SSI) system under the constraints of telecom networks so that a user or a network node holding such an identity can access network services among different operators and service providers seamlessly.

Procedures related to trust evaluation and management are described herein. Trust may refer to a measurable belief that represents an accumulated value (e.g. quality/behavior/performance/characteristic of a network node, a WTRU, a service or any logical/physical entity) from history and the expected future value. Trust may be objective trust or subjective trust. Objective trust may leverage security mechanism(s), such as authentication, to validate an entity's identity. However, trust may include and go beyond security. For example, an entity successfully passing an authentication procedure may mean that the entity has successfully proved its identity, however the entity still may not be fully trusted because, for example, the trust about the entity's behavior/characteristics may be dynamically changing and/or the criteria for evaluating trust may also be subjective (e.g., based on user/personal experience/preference). Trust is an essential input for decision making and it is usually measured or calculated based on the history experience/records in the past, and it represents the expected value of quality, behavior, characteristics, and/or future performance.

In an example, a trust index may be obtained via a trust evaluation process. A trust index may be used to describe the trust of an entity. The trust index may be, for example, an overall metric, which may be calculated based on the aggregation of one or more trust indicators (depending on the user's subjective trust evaluation criteria) using certain trust evaluation algorithms. The trust indicators may cover various aspects, such as security, privacy, resilience, performance, robustness, scalability, reputation, availability, accuracy, reliability, and/or consistency. During a trust evaluation process, various data about an entity may be collected and the collected data may be used as inputs to calculate various trust indicators, which in turn may be aggregated into an overall metric (i.e., the current trust index of the entity). Trust has various characteristics. For example, trust may be dynamic, meaning that a given trust index may be applicable for a limited time period and may change as time goes on. Trust may be context-dependent, which means that the trust may have a significant change if the context gets changed. Trust may not be transitive in nature, but trust may be transitive in some particular contexts. Similarly, trust may be an asymmetric relationship, meaning that entity A trusting entity B does not imply that entity B also trusts entity A. In addition, trust may be subjective, which means that for the same entity, different users may have different criteria/opinions/preferences regarding how to evaluate the trust of the entity and what kinds of trust-related aspects/indicators may be considered.

Existing cellular wireless systems (e.g., 5GS) may provide various security functions such as primary authentication during registration, secondary authentication during Protocol Data Unit (PDU) session establishment, NF service authorization, network slicing-specific authentication and authorization, network slicing admission control, and data plane encryption and integrity protection.NF service authorization in 5GS may be static authorization or token-based authorization. According to static authorization, some local authorization policies may be maintained at NRF and NF service producer. Those local authorization policies may be used to authorize a NF service consumer, for example when the NF service consumer discovers NF service producers from NRF or when the NF service consumer requests to access services from a discovered NF service producer. According to token-based authorization, NRF may grant an access token to a NF service consumer. The NF service consumer may present the access token to the NF service producer, which may authorize the NF service consumer based on the access token.

In future wireless system, a user may access services provided by a network and/or a WTRU with highly dynamic behavior. Examples of services may include NWDAF, AI as a Service (AIaaS), Computation as a Service (CaaS), and/or Sensing as a Service. Dynamic behaviors may be for the user to access services from a new location, to access services from a new network slice, to access services via different devices at different times, to switch to access services provided by another device for a reduced latency and/or other improvement in performance or experience. Such dynamic behaviors may lead to changing trustworthiness among interacting and involved entities (e.g., users, devices, NFs, networks, etc.). For example, a previously established relationship between a user and a NF may become not trustable anymore. The user may be a human user, an application on a device, an application within a network, a device behind another device, or any other logical entity as a service consumer.

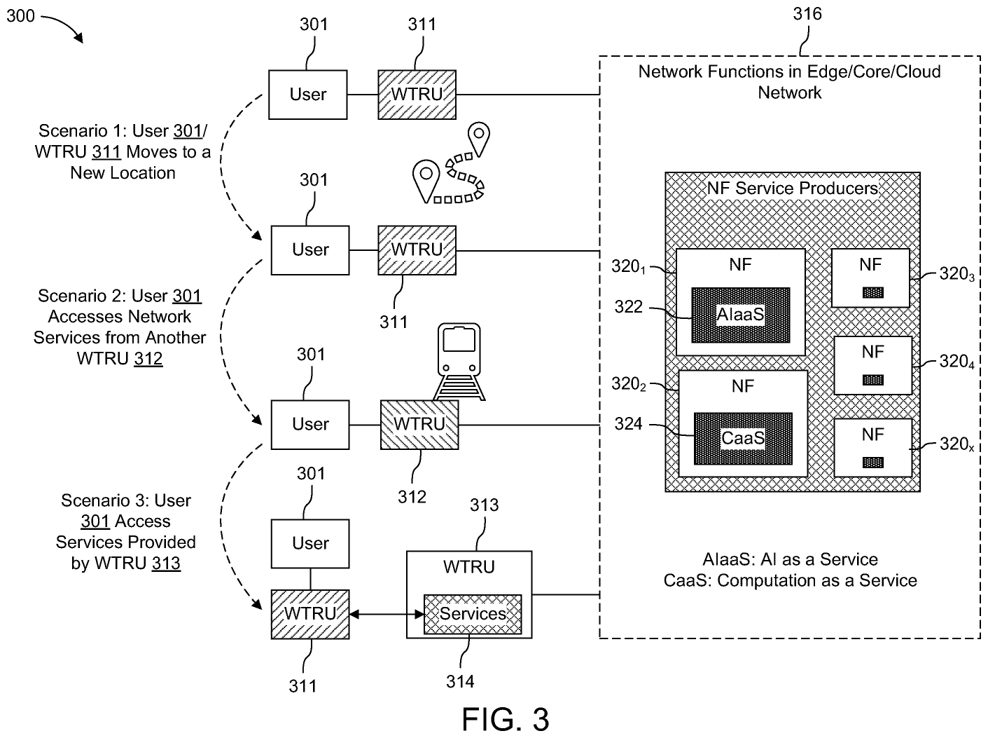

FIG. 3 is a system diagram illustrating example scenarios of dynamic service access from a user 301 in an example communications system 300. Network functions in the (edge/core/cloud) network 316 may include x NF services producers 320₁, 320₂, 320₃, 320₄, . . . , 320ₓ. In this example, NF service 320₁ provides AIaaS 322, and NF service 320₂ provides CaaS 324. According to example scenario 1, user 301 is currently using WTRU 311 to interact with network 316. According to example scenario 1, user 301/WTRU 311 may move to a new location (e.g., a train station) and may continue to access services from a network 316 (e.g., example service AIaaS 322 provided by NF 320₁). Moving to a public area with more potential security attacks may lead to a change to the trust of user 301/WTRU 311.

According to example scenario 2, a mounted WTRU, WTRU 312, may be mounted on a moving vehicle such as the train, which may provide better wireless connectivity and overall performance to the user 301 while the training is moving. User 301 may get on the train and change from associating with WTRU 311 to associating with and using WTRU 312 to access network services (e.g., CaaS 324 provided by NF 320₂) in network 316. For example, WTRU 312 may provide a WiFi-based hotspot service within the train. For example, each seat may have a built-in WiFi terminal. As a result, user 301 may uses the built-in WiFi terminal to connect to WTRU 312 and eventually get to access network services in network 316. In another example (not shown), user 301 may continue to use WTRU 311 to connect to WTRU 312 (e.g., via WiFi or sidelink) to access network services in network 316.

According to example scenario 3, while using AIaaS 322 from NF 320₁, user 301/WTRU 311 may arrive at a destination (e.g., a shopping mall) and disembark from the train at the destination. At the destination, WTRU 313 (e.g., a WTRU at a store in the shopping mall) in the proximity of WTRU 311 may provide needed services such as AIaaS 314. Services such as AIaaS 314 on WTRU 313 may provide a store-customized AI model for shopping suggestions for free. In this case, user 301 may change to access AIaaS services 314 from WTRU 313 and stop accessing AIaaS 322 from NF 320₁.

In the example dynamic service access scenarios in FIG. 3, the user's 301 context (e.g., the location of user 301, the WTRU that user 301 is associated with, and/or the location of services being accessed) changes over time. As such, the trust index of user 301 may be changing too. Thus, authorization of user 301 to access network services or services provided by a WTRU needs to be dynamically (re-) assessed over time. Existing 5GS may have any of following limitations in supporting the example dynamic service access scenarios in FIG. 3. For example, 5GS may not fully consider dynamic user context, unless the context is part of a network slice, and may not well support dynamic user authentication. Primary authentication in 5GS may be based on statically configured information (i.e., the root key in USIM), which may not reflect or capture the dynamically changing user context and user trust index. A subsequent primary (re) authentication run may be initiated by an AMF (e.g., by a target AMF during a change of AMF). However, this type of (re) authentication is left to implementation and based on network local policy. Static authorization in 5GS may only be based on local authorization policies, which may not reflect or capture the dynamically changing user context and user trust index. In token-based authorization in 5GS, access token may not reflect or capture the dynamically changing user context and user trust index. Additionally, 5GS does not support dynamic user authentication based on user trust index. Existing solutions for user identifier and user authentication may not reflect or support user trust index.

For existing wireless systems where a user is authenticated only once, the user may continue to access network services for extended periods of time, including after the user context changes, resulting in degraded user trust index, and/or after a service producer's trust changes. This results in the wireless system being less secure and more vulnerable from potential attacks. Accordingly, procedures and solutions are disclosed herein to support dynamic user authentication by leveraging trust so that service access in a wireless system may be user-aware and trustworthy.

In an example, existing request/response-based direct service interaction under dynamic service access scenarios may not be trustworthy. In existing 5G request/response-based direct service interaction, a NF service consumer may get an access token from NRF and present the access token to a NF service producer when issuing service requests. Then, the NF service producer may authenticate and authorize the NF service consumer according to the access token. However, an authorized access token does not guarantee trustworthy service interactions because the trust index of both the NF service consumer and the NF service producer may be highly dynamic and change under various conditions (e.g., by moving to a public area or using an access service from a public device). Future wireless system, such as 6GS, may require trustworthy service interactions in order to take into account dynamic user trust, device trust, and service producer trust.

An issue is how to incorporate trust indexes (e.g., user, device, and service producer trust indexes) into the authorization process between a NF service consumer and a NF service producer to enable trustworthy service interactions, even when the trust index of the NF service consumer and the NF service producer changes dynamically. A related issue is how the trust index of the NF service consumer may be efficiently provided to the NF service producer based on different NF deployment scenarios.

The following terms are applicable to the proposed solutions herein. A device may be a WTRU, such as a 3GPP UE. A device may be a non-UE that connects to a WTRU via a non-cellular link to get to a cellular network. A device may have one or multiple on-device applications. A user may be the entity (e.g., a human user, but not necessarily a human user) that uses a device. A user may be outside of a device or an entity within the device. For example, a NF consumer may be a user, a FESC may be a user, and/or an application running on a WTRU may be a user. A WTRU (e.g., a WTRU without USIM) may be a user. A device that uses a WTRU to get access to 3GPP network may be a user of the WTRU.

A Function Entity (FE) may be a processing function, such as any network function. A FE may be, for example, an AF, a function at an edge network, a function at a radio access network, an edge application or service, a service provided by a device, an application provided at a device, a server or service in a data network. An FE Service Consumer (FESC) may be an FE that accesses services provided by FE service producers (e.g., NF service producer). An FESC may be an NF service consumer. A device may be a FESC. A single device may have multiple FESCs. A FESC may be referred to as a service consumer or as a consumer when used herein and may be in the context of 3GPP systems or non-3GPP systems. An FE Service Producer (FESP) may be an FE that provides services to FESC(s). A FESP may be a NF service producer, an AF, a function at an edge network, a function at a radio access network, an edge application service, a service enabler, or a service on another device. A device may be a FESP. A single device may have multiple FESPs. A FESP may be referred to as a service producer or as a producer when used herein and may be in the context of 3GPP systems or non-3GPP systems.

A trust index may be a metric to show/represent/reflect the trustworthiness of a logical or a physical entity (e.g., a device, a user, and/or an FE). Trust index may be an absolute floating number or an integer (e.g., the higher the trust index of the entity is, the more trustworthy the entity is). Trust index also may be categorical data to indicate multiple levels of trust (e.g., “very low trust”, “low trust”, “medium trust”, “high trust”, “very high trust”, etc.). As a result, a trust index threshold may be a number or a trust level. Trust index may be calculated during a long or a short period of time and thus it may be an instantaneous trust index or an average trust index. Trust index of an entity may be a reputation value of this entity or based on a reputation value of this entity. The Device Trust Index (DTI) may be the trust index of a device. The User Trust Index (UTI) may be the trust index of a user. A Trust Management Function (TMF) may be an FE that can assess and calculate the trust index of an entity (e.g., a device, a user, an AF, a NF, a service, an application). TMF may (or may not) expose the calculated trust index to other FEs. TMF may assess and calculate the trust index of FESCs and FESPs.

An identifier may be the name/identifier/address of an entity (e.g., a user, a device, a FE, an entity using a device). An identifier may be for example a 3GPP identifier, an IP address, a URL (Uniform Resource Locator), a FQDN (Fully Qualified Domain Name), a blockchain address, or a distributed user identifier. The identifier of an entity may enable or give access details based on which other entities can access and interact with this entity. A Distributed User Identifier (DUID) may be a special type of identifier for a user that can be created and owned by the user without relying on a third party. A DUID may be independently formed or established by the user using a DUID generation algorithm or function, which may be based on some unique and private information of the user such as a private key, user attributes, user properties, an/or user biometrics. Any entity (e.g., a device, an application on the device, a service provided at a device, a NF) may create and possess a DUID. A Distributed Verifiable User Credential (DVUC) is a credential being created or issued for a user. DVUC may be verified and authenticated in a distributed way without contacting the party that created the DVUC. A user may have one or multiple DVUCs. When an unauthorized user needs to access services from an entity such as a NF, the user may present a DVUC to the entity to get the DVUC authenticated and eventually establish a trust relationship with the entity offering services. A new DVUC may deprecate an existing DVUC. A new DVUC may be dependent on one or multiple existing DVUC.

Multiple procedures and solutions are proposed herein for trust-based authentication considering user trust and/or device trust for a service consumer and/or the trust index of a service producer, which have the following design principles and benefits. Design principles of the procedures and solutions proposed herein may include any one or more of the following: flexible and applicable for different use cases (e.g., scenarios in FIG. 3); avoid introducing high communication or computation overhead to devices; compatible with 3GPP architecture; and/or integrate with 3GPP SA procedures. Benefits of the procedures and solutions proposed herein may include any one or more of the following: more user-aware wireless system by incorporating user trust index, device trust index, and service producer trust into user authentication; and/or more secure service interaction via trust-based authentication considering dynamically changing user trust index.

To enable trustworthy direct service interactions between a service consumer/FESC (e.g., a user, application client, or other function on a WTRU) and a service producer/FESP (e.g., a WTRU, a NF, an AF/AS, an edge application server (EAS,) service enabler) using a request/response service model, dynamic trust-based authentication (DTA) is proposed as a new functionality of a service producer/FESP to authenticate and authorize the service consumer/FESC by considering the dynamic trust index of the service consumer/FESC and the service producer/FESP. For example, the service producer/FESP may be realized by a Network Exposure Function (NEF).

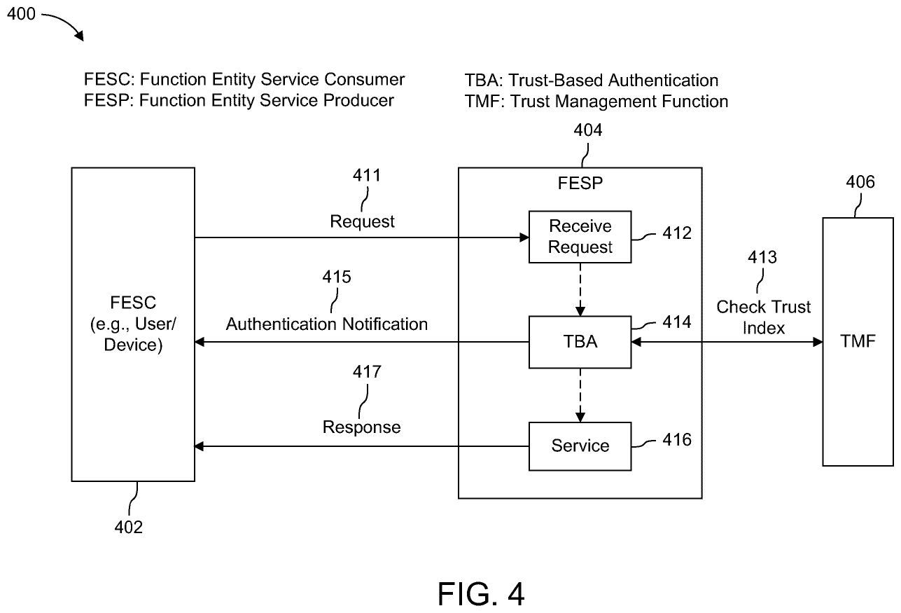

FIG. 4 is a signaling diagram illustrating an example message exchanges for dynamic trust-based authentication architecture 400 for a request/response-based service interaction. The example architecture 400 includes service consumer/FESC 402 (e.g., a user and/or a device), service producer/FESP 404 (e.g., NF or a service on another device), and TMF 406. In the example of FIG. 4, the FESC 402 has discovered the FESP 404, and the FESC 402 needs to access a target service 416 provided or hosted by the FESP 404. The FESC 402 may directly send a request message 411 for accessing the target service 416 to the FESP 404. At 412, the FESP 404 may receive the request message 411 and may perform some basic processing (e.g., credential-based authentication). The FESP 404 may perform trust-based authentication 414 by checking/retrieving the trust index 413 of the FESC 402 from a TMF 406. In an example, the TMF 406 may push the trust index 413 of the FESC 402 to the FESP 404 (e.g., as instructed by the FESC 402). The FESP 404 may use the trust index 413 of the FESC 402 to perform Dynamic Trust-based Authentication (DTA) over the request message 411 received from the FESC 402. The 404 FESP may send an authentication notification 415 to the FESC 302, which may contain the trust-based authentication result. If the FESC 402 is allowed to request the target service 416 according to the trust-based authentication, the FESP 404 may execute the target service 416 for the FESC 402. When the execution of the target service 416 is complete, the FESP 404 may collect service results, include the service results in a response message 417, and send the response message 417 to the FESC 402. Any subset of the procedures and parameters described hereinafter may be used in the example message exchanges for dynamic trust-based authentication in FIG. 4 to further enhance the trust-based authentication between FESC 402, FESP 404 and TMF 406.

Example procedures are disclosed herein for dynamic trust-based authentication for request/response direct service interaction. An example procedure for dynamic trust-based authentication for request/response-based direct service interaction may involve a service producer/FESP retrieving a trust index from a TMF. FIG. 5 is a signaling diagram illustrating an example procedure 500 for dynamical trust-based authentication for request/response-based service interaction where a FESP 504 retrieves a trust index. The communication system for the example procedure 500 may include a user/device 502, which may be a user using a device or a user behind the device, FESP 504, and TMF 506. Other network functions and devices, not shown, may be included. In this example, user/device 502, user 502, and device 502 may be used to refer to, respectively, the combination of the user and device, and the user and the device independently. User/device 502 may be a service consumer/FESC 502 that requests to access target services provided by a service producer/FESP 504. FESP 504 may be service producer within a network (e.g., 5G or 6G network) or on a device. FESP 504 may be a service producer providing services to user/device 502 acting as a service consumer. The TMF 506 may provide services for evaluating, calculating, and exposing a trust index, such as a UTI, DTI, and/or the trust index of FESP 504. TMF 506 may be within the network (e.g., 5G or 6G network) or a third-party entity.

In the example procedure 500, it may be assumed that user/device 502 has received or been configured with a list of FESPs that provide target services. It may be further assumed that user/device 502 may select or discover some FESPs, such as FESP 504, to access their services. It may also be assumed that user/device 502 has been provisioned with or has obtained a TMF 502. At a high level, user/device 502 may retrieves FESP's 504 trust index from the TMF 506 by sending a request message 511 to the TMF 506, and may authenticate the FESP 504 based on its trust index, as determined from the response message 512 from the TMF 506. User/device 502 may request to access target services provided by FESP 504. Before providing the requested services to user/device 502, FESP 504 may (jointly) perform device level static authentication, user level static authentication, and/or dynamic trust-based authentication to determine if user/device 502 is allowed to access the requested target services. For dynamic trust-based authentication, FESP 504 may at 530 retrieve UTI and DTI from TMF 506, based on which FESP 504 may determine if user/device 502 can be trusted. Then, FESP 504 may send authentication result using authentication notification 523 to user/device 502 and, at 525, start to executing requested services. The FESP 504 may send service execution results in service operation response 526 to user/device 502. The detailed steps of the example procedure 500 are described hereinafter.

User/device 502 may send a request message 511 to TMF 506 to retrieve the trust index of FESP 504. The request message 511 may contain the following parameters: a FESPID, a TrustIndexMode, and/or a TrustIndex TimeWindow. The FESPID may be an identifier of FESP 504. The TrustIndexMode may indicate the mode of the requested trust index, and may have any of the following example values. The TrustIndexMode may have value “RecentAverage”, which may represent the user/device 502 requests TMF 506 to calculate and return the average trust index of FESP 504 in the most recent period of time as indicated by TrustIndex TimeWindow. TrustIndexMode may have value “MultiAverage”, which may represent the user/device 502 requests TMF 506 to return the average trust index of FESP 504 in multiple time windows up to the present. TrustIndexMode may have value “Instant” “, which may represent the user/device 502 requests TMF 506 to calculate and return the instantaneous trust index of FESP 504. TrustIndexTimeWindow may indicate a time window to calculate the average trust index of FESP 504. According to TrustIndexMode and TrustIndexTimeWindow, TMF 506 may look up already calculated trust index and/or recalculate the up-to-date trust index of FESP 504, and may send the requested trust index in a response message 512 to user/device 502.

As an alternative approach to message exchanges 511 and 512, user/device 502 may send request message 511 to subscribe to changes of FESP's 504 trust index (e.g., when FESP's 504 trust index is below a threshold and/or above another threshold). In this case, request message 511 may contain some notification criteria on FESP's 504 trust index. For example, a criteria may be “FESP's trust index is below a specific threshold”. Then, TMF 506 may generate automatic notifications about FESP's 504 current trust index when it meets the notification criteria. Such notifications on FESP's 504 current trust index may be repeatedly sent from TMF 506 to FESC 502. After receiving a notification from TMF506, FESC 502 may proceed to step 513.

At 513, user/device 502 may authenticate FESP 504 based on FESP's 504 trust index. For example, if FESP's 504 trust index is too low, user/device 502 may decide not to access FESP's 504 services and all the remaining steps of procedure 500 may be skipped. If FESP's 504 trust index is greater than a value (e.g., a preconfigured threshold), user/device 502 may continue with the following steps of procedure 500 to access the target services from FESP 504. Messages 511 and 512 and authentication step 513 are used by the user/device 502 to authenticate FESP 504, and thus may not be performed if the user/device 502 has already authenticated FESP 504. In an example, user/device 502 may sequentially send multiple service operation requests 514 to FESP 504.

User/device 502 may send a service operation request 514 to FESP 504 to access target services provided by FESP 504. The service operation request 514 may include any one or more of the following parameters: FESPTIAuthReq; FESCTIAuthSupport; DevID; UserID; UserCredential; ServiceID; ServiceOperationType; TMFID; AuthNotifAddr; CredentialForTMF; TrustIndexNotifFlag; TrustIndexMode; TrustIndexTimeWindow; and/or OperationResponse Timer. These parameter are described in the following. FESPTIAuthReq may be an indication that the user/device 502 will authenticate and authorize the FESP 504 using a trust index of the FESP 504. FESCTIAuthSupport may be an indication that the user/device 502 supports or requests to be authenticated and authorized by the FESP 504 using at least one of: a user trust index (UTI) of the user and/or a device trust index (DTI) of the device 502. DevID may be the identifier of device 502. When device 502 is a WTRU, DevID may be for example Subscription Concealed Identifier (SUCI), Globally Unique Temporary Identifier (GUTI), and/or Subscription Permanent Identifier (SUPI). UserID may be the identifier of user 502, and may be for example an application identifier when user 502 is an application, a device identifier when user 502 is a device, an email address of user 502, a username of user's 502 social account, a username of user's 502 online account, a Self-Sovereign Identifier (SSI) of user 502, a blockchain address of user 502, or a DUID of user 502. UserCredential may be the credential of user 502, and may be for example a DVUC or an access token. For example, FESP 504 may use UserCredential in step 515 to authenticate user 502.

ServiceID may be the identifier(s), name, and/or type of target services that user/device 502 requests to access. The ServiceID parameter may include multiple service identifiers if user/device 502 requests multiple services. If the service operation request 514 is to discover services at FESP 504, the ServiceID parameter may not include any specific service identifier, but a service filter to describe target services that user/device 502 wants to discover. ServiceOperation Type may be the type of service operation being requested. Potential service operations may include to invoke/execute a service, to update a service, to subscribe a service, to pause or stop an invoked service, and/or to retrieve information about a service. Different target services may provide different service operations. TMFID may be the identifier of TMF 506. The TMFID parameter may contain the details for FESP 504 to send request message 519 to TMF 506. Alternatively, FESP 504 may use TMFID to discover access details (e.g., API address, IP address plus port number) of TMF 506 from the FESP's 504 local database or a remote repository (e.g., an NRF, not shown). In an example, if the TMFID parameter is included in service operation request 514, then step 517 to select a TMF may be skipped.

AuthNotifAddr may be the address for receiving the authentication notification 523. If the AuthNotifAddr parameter is not included in service operation request 514, then the authentication notification message 523 and the authentication confirmation message 524 may be skipped. CredentialForTMF may be the credential to be used by FESP 504 for retrieving UTI and DTI from TMF 506 in 516. If the AuthNotifAdd parameter is not included in service operation request message 514, FESP 504 may determine and include another CredentialForTMF by itself and use it in step 519. TrustIndexNotifFlag may be the indicator for user/device 502 to ask the FESP 504 to provide the UTI and DTI that are used to authenticate the FESC 502. Then, the FESP 504 may provide the UTI and DTI to user/device 502 in the authentication notification 523. For example, if TrustIndexNotifFlag=TRUE or ‘1’, the FESP 504 may include UTI and DTI in authentication notification message 523 to user/device 502.

TrustIndexMode may indicate the mode of the requested trust index of FESP 504, which user/device 502 may request FESP 504 to send back in authentication notification message 523. This parameter may not be needed if steps 511, 512, and 513 have been performed. TrustIndexMode may have any of the following example values. The TrustIndexMode may have value “RecentAverage”, which may represent the user/device 502 requests TMF 506 to calculate and return the average trust index of FESP 504 in the most recent period of time as indicated by TrustIndex TimeWindow. TrustIndexMode may have value “MultiAverage”, which may represent the user/device 502 requests TMF 506 to return the average trust index of FESP 504 in multiple time windows up to the present. TrustIndexMode may have value “Instant” “, which may represent the user/device 502 requests TMF 506 to calculate and return the instantaneous trust index of FESP 504. TrustIndex TimeWindow may indicate a time window to calculate the average trust index of FESP 504. The TrustIndexTimeWindow parameter may not be needed if steps 511, 412, and 513 have been performed. OperationResponseTimer may be a timer indicating that FESP 504 needs to send a service operation response to user/device 502 before the OperationResponseTimer timer expires.

FESP 504 may receive the service operation request 514. At 515, FESP 504 may authenticate the service operation request 514 based on user credential(s). The authentication 515 of service operation request 514 based on credentials may include any of the following operations and may include authentication result(s) in the parameter AuthResult, which may include three sub-parameters: DeviceLevelAuth, UserLevelAuth, and TrustLevelAuth. As an example operation that may be part of the authentication 515, FESP 504 may check if parameter DevID received in service operation request 514 is a valid device identifier. For this purpose, FESP 504 may contact a UDM (not shown) for subscription data and/or include other NFs (e.g., AMF, not shown) to verify that parameter DevID is still valid. As another example operation that may be part of the authentication 515, FESP 504 may check if device 502 is allowed to send the service operation request 514 to FESP 504 based on device's 502 current location or service area according to some policies, which FESP 504 may maintain locally or retrieve from PCF (not shown). If the operations to check credentials as part of authentication 515 pass, sub-parameter DeviceLevelAuth may be set to “Successful Device Authentication”; otherwise, DeviceLevelAuth may be set to “Failed Device Authentication”. In an example, device 502 is a public WTRU (e.g., a train-mounted WTRU) available for any users to use, and the above checks part of authentication 515 may be skipped and DeviceLevelAuth may be set to “Not Needed”.

As another example operation that may be part of the authentication 515, FESP 504 may check if parameter UserID received as part of the service operation request 514 a valid user identifier. For this purpose, FESP 504 may check a user profile maintained within the network (or by a third-party entity) to verify UserID. For this purpose, FESP 504 may contact an authentication server (not shown), which may be within the network or a third-party entity. If the operation to check credentials as part of authentication 515 passes, UserLevelAuth may be set to “Successful User Authentication”; otherwise, UserLevelAuth may be set to “Failed User Authentication”. In an example, if DeviceLevelAuth=“Failed Device Authentication”, any or all subsequent steps of procedure 500, except the sending of authentication notification message 523, may be skipped and FESP 504 may send DeviceLevelAuth=“Failed Device Authentication” to user/device 502 in authentication notification message 523. In an example, if UserLevelAuth=“Failed User Authentication”, any or all subsequent steps of procedure 500, except the sending of authentication notification message 523, may be skipped and FESP 504 may send AuthResult to user/device in in authentication notification message 523.

In an example, FESP 504 may check parameter OperationResponse Timer. FESP 504 may reject the service operation request 514 if FESP 504 knows it cannot finish executing the requested service operation and generating a service operation response before the OperationResponse Timer timer expires (e.g., the timer duration is too short/small). Then, FESP 504 may include “a rejection message (e.g., too short OperationResponseTimer)” in service operation response message 526 and any or all steps 516-525 may be skipped.

If authentication 515 fails, FESP 504 may forward the service operation request 514 and/or send a failed authentication indication to TMF 506, and the TMF 506 may recalculate and update the trust index of user/device 502 (e.g., decrease it) based on the service operation request and/or the failed authentication indication (not shown). In this case, TMF 506 recalculate and update the trust index of user/device 502 (e.g., decrease it) based on the failed authentication indication and/or the service operation request 514, and may send a response to FESP 504 indicating the receipt of the failed authentication indication and/or the recalculated trust index of user/device 502 (not shown). TMF 506 may send the recalculated trust index of user/device 502 to user/device 502 (not shown). If authentication 515 is successful, FESP 504 may forward the service operation request 514 and/or a successful authentication indication to TMF 506, and the TMF 506 may recalculate and update the trust index of user/device 502 (e.g., increase it) based on the service operation request and/or the successful authentication indication (not shown). TMF 506 may send a response to FESP 504 indicating the receipt of the successful authentication indication and/or the recalculated trust index of user/device 502 (not shown). TMF 506 may send the recalculated trust index of user/device 502 to user/device 502 (not shown).

At 516, FESP 504 may determine if further trust level (trust-based) authentication of user/device 502 is needed. For example, FESP 504 may maintain local service policies that describe if FESP 504 services need trust-based authentication for any particular user/device 502. In an example of a FESP service policy as part of trust level authentication 516, the FESP 504 may determine that access from any user/device 502 to a service with ServiceID=“ServiceID-Example-123” needs trust-based authentication. In another example of a FESP service policy as part of trust level authentication 516, the FESP 504 may determine that access from a user/device 502 (UserID=“UserID-Example-123” and DevID=“DevID-Example-123”) to a service with ServiceID=“ServiceID-Example-456” needs trust-based authentication. In another example of a FESP service policy as part of trust level authentication 516, the FESP 504 may determine that access from a user/device 502 (UserID=“UserID-Example-456” and DevID=“DevID-Example-456”) to a service with ServiceID=“ServiceID-Example-456” does not need trust-based authentication. If at 516 FESP 504 determines that trust-based authentication is not needed, steps 517-522 may be skipped.

At 517, FESP 504 may select a TMF 506. FESP 504 may have been provisioned with multiple TMFs, for example indications of TMFs may be included in service operation request message 514. From among known TMFs, FESP 504 may select a TMF 506 that can provide UTI and DTI for user/device 502. If an indicated TMFID is included in service operation request 514, then FESP 504 may skip TMF selection 517. If an indication of a TMFID is not included in service operation request 514, FESP 504 may use UserID and DevID to search for a TMF (e.g., from NRF, not shown) that can provide UTI and DTI for user/device 502. At 518, FESP 504 may check if the selected TMF 506 (or the TMF 506 as indicated in service operation request message 514) can be trusted. If the selected TMF 506 is from TMFs indicated in or derived from service operation request message 514, FESP 504 may use any one or more of the following steps to authenticate the selected TMF 506. As part of TMF authentication 518, FESP 504 may send UserID and DevID to the selected TMF 506 and request the selected TMF 506 to send back a TMF credential, which can demonstrate that the selected TMF can trustfully provide UTI and DTI for user/device 502 as denoted by UserID and DevID. As part of TMF authentication 518, the selected TMF 506 may send a TMF credential to FESP 504. As part of TMF authentication 518, FESP 504 may present the TMF credential to an authentication server (not shown). Alternatively, FESP 504 may verify the TMF 506 credential itself. As part of TMF authentication 518, the authentication server (not shown) may receive the TMF credential and verify it. As part of TMF authentication 518, the authentication server (not shown) may send a response to FESP 504 to indicate that the TMF credential has been verified and the selected TMF 506 can be trusted. If the selected TMF 506 is a TMF provisioned to FESP 504, the selected TMF 506 may be considered trustable and TMF authentication 518 may be skipped. If the selected TMF 506 cannot be successfully authenticated, FESP 504 may go back to TMF selection 517 to re-select a different TMF and then repeat TMF authentication 518. In an example. TMF selection 517 and TMF authentication 518 may take place between service operation request message 514 and authentication step 515, or between authentication step 515 and trust level authentication 516.

The retrieve trust index procedure 530 may include any one or more of actions 519, 520, and/or 521. FESP 504 may send request message 519 to the selected and authenticated TMF 506 to request and retrieve UTI for user 502 and DTI for WTRU 502. Request message 519 may include any one or more of the following parameters: DevID (described hereinbefore); UserID (described hereinbefore); CredentialForTMF, which may be the credential for retrieving UTI and DTI from the TMF 506, and may be received in service operation request 514 or determined by FESP 504 during the retrieve trust index procedure 530; FESPID, which may be the identifier of FESP 504; and/or TrustIndexMaxAge, which may indicate the freshness of UTI and DTI to be retrieved. For example, if TrustIndexMaxAge=“5 Minutes”, it indicates that FESP 504 requests UTI and DTI to be calculated in less than 5 minutes. If TrustIndexMaxAge=“0 Minute”, it indicates that FESP 504 requests the TMF 506 to recalculate UTI and DTI. At 520, the TMF 506 may authenticate if FESP 504 can retrieve UTI and DTI based on the parameter CredentialForTMF. At 520, the TMF 506 may check if UTI and DTI have been calculated for user/device 502 and if UTI and DTI satisfy TrustIndexMaxAge. If TrustIndexMaxAge=“0 Minute”, the TMF 506 may recalculate UTI and DTI for user/device 502. The TMF 506 may send a response message 521 to FESP 504 including the UTI and DTI determined in lookup step 520. Response message 521 may include TrustIndexAge, which may indicate the time (e.g., timestamp) when UTI and DTI were last calculated.

FESP 504 may perform authentication 522 of the service operation request 514, according to UTI and DTI included in response message 521. For example, if UTI is greater than a UTI threshold and DTI is greater than a DTI threshold, the service operation request 514 passes trust-based authentication. In this case, FESP 504 may set TrustLevelAuth=“Successful Trust-based Authentication”. In an example, if UTI is below a UTI threshold and/or DTI is below a DTI threshold, FESP 504 may set TrustLevelAuth=“Failed Trust-based Authentication”. In an example, the UTI threshold and the DTI threshold may have been provisioned to FESP 504 as a part of FESP service policies. Two FESP services may be configured with the same or different UTI threshold and DTI threshold. In another example, both UTI and DTI may be greater than a common trust index threshold, in which case the service operation request 514 passes trust-based authentication. In another example, if the sum of UTI and DTI (or other form of combination of UTI and DTI) is greater than a common trust index threshold, the service operation request 514 passes trust-based authentication. As part of authentication 522, FESP 504 may determine if UTI and DTI need to be contained in authentication 523 according to TrustIndexNotifFlag and/or FESP service policies. In an example, FESP service policies may take precedence over TrustIndexNotifFlag.

FESP 504 may send an authentication notification 523 to user/device 502. Authentication notification 523 may include any one or more of the following parameters: AuthResult, which may include sub-parameters DeviceLevelAuth, UserLevelAuth, and TrustLevelAuth (DeviceLevelAuth and UserLevelAuth may have been determined in authentication step 515, and TrustLevelAuth may have been determined in authentication step 522); UTI, which may be the trust index of user 502 as received in response 521; and/or DTI, which may be the trust index of device 502 as received in response 521. FESP 504 may include the UTI threshold, DTI threshold, and/or the common trust index threshold in the authentication notification message 523, for example when AuthResult indicates that the trust-based authentication has failed. If TrustIndexMode and/or TrustIndexTimeWindow are included in service operation request 514, FESP 504 may include its trust index (e.g., FESPTrustIndex) in authentication notification 523. FESP 504 may obtain its trust index from TMF 506 (not shown).

User/device 502 may send authentication confirmation 524 to the FESP 504 in response to receiving authentication notification message 523. According to the parameter AuthResult included in authentication notification message 523, user/device 502 may determine if the service operation request 514 has been successfully authenticated and if a service operation response is expected (i.e., service operation response 526). In an example, based on the UTI threshold, DTI threshold, and/or the common trust index threshold, user 502 may change to use a new device (different from original device 502) with a higher DTI to access FESP services at FESP 504 (assuming user 502 knows multiple devices that user 502 can use). If user 502 changes devices, the identifier of the new device may be included in the authentication confirmation 524. User/device 502 may store the received UTI and DTI locally. If authentication notification message 523 includes parameter FESPTrustIndex, then user/device 502 may use or repeat the authentication step 513 to authenticate FESP 504 (e.g., this may occur when steps 511, 512, and 513 have not been performed at all or have not been performed for a long duration of time). In this case, user/device 502 may send authentication confirmation message 524 to FESP 504, and authentication confirmation message 524 may include the identifier of the new device. If a new device is indicated in authentication confirmation message 524, FESP 504 may repeat steps 519, 520, 521, and 522 to re-authenticate user 502 and/or new device prior to executing the requested service operation 525. Authentication confirmation 524 may indicate if FESP 504 has been successful authenticated. Authentication confirmation 524 may indicate any potential change to the service operation requested by service operation request message 514. For example, user/device 502 may change the service operation and related parameters according to parameter FESPTrustIndex. If the value of FESPTrustIndex is too small, authentication confirmation message 524 may include an indication to cancel the service operation as requested in service operation request message 514.

FESP 504 may execute the requested service operation 525, as requested in service operation request message 514 and/or authentication confirmation 524, and generate service results if the requested service operation has not been cancelled in authentication confirmation 524. If the authentication confirmation 524 indicates any changes to the requested service operation, FESP 504 may enforce these changes when executing the requested service operation 525. FESP 504 may send a service operation response 536 including the service result to user/device 502. Device 502 may first receive the service operation response 526 from FESP 504 and then pass it to user 502. User 502 may perform any of the followings actions, not shown, based on the service operation response 526. For example, user 502 may forward the service results included in service operation response 526 to an application server or next application function in a chain of application functions. In another example, user 502 may leverage the service results to determine next service operations request to be sent to the same FESP 504 or a different FESP, store the service results locally, send the service results to a third-party for auditing, store the service results to distributed ledgers or a blockchain permanently, and/or send the service results to a charging function for online or offline charging for user/device 502. In another example, based on the UTI threshold, DTI threshold, and/or the common trust index threshold, user 502 may change to use a different device with a higher DTI to access FESP services.

In a further example not shown, if user/device 502 does not receive the service operation response 526 before expiry of OperationResponseTimer timer, user/device 502 may determine that FESP 504 has not received or has not processed the service operation request 514. In this case, user/device 502 may send a failure message (e.g., indicating “user/device 502 did not receive the service operation response 526 from FESP 504 before OperationResponseTimer expires at location L1”) to TMF 506. Location L1 may be the current geographical location of user/device 502. The failure message may include the service operation request 514. TMF 506 may receive the failure message and recalculate the trust index of FESP 504 (e.g., decrease it) according to the failure message. TMF 506 may send a response to user/device 502 indicating the receipt of the failure message and/or the recalculated trust index of FESP 504. TMF 506 may send the recalculated trust index of FESP 504 to FESP 504.

In a further example not shown, after successfully receiving the service operation response 526, user/device 502 may send a success message (e.g., indicating “user/device 502 received the service operation response 526 from FESP 504 at time T1 at location L1”) to TMF 506. Time T1 may be the time of receiving the service operation response 526 and location L1 may be the current geographic location of user/device 502. TMF 506 may recalculate the trust index of FESP 504 (e.g., increase it) according to the success message. TMF 506 may send a response to user/device 502 indicating the receipt of the success message and/or the recalculated trust index of FESP 504. TMF 506 may send the recalculated trust index of FESP 504 to FESP 504.

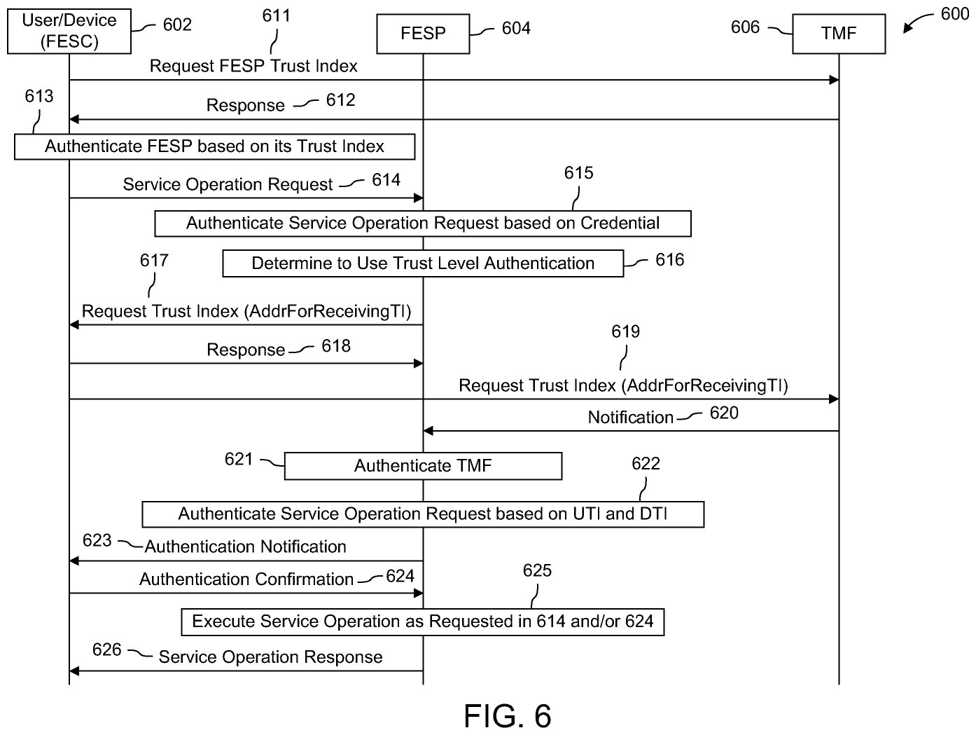

Another example procedure for dynamic trust-based authentication for request/response-based direct service interaction may involve a TMF forwarding a trust index to a FESP. FIG. 6 is a signaling diagram illustrating an example procedure 600 for dynamical trust-based authentication for request/response service interaction where a TMF 606 forwards a trust index to a FESP 604. The procedure 600 illustrated in FIG. 6 may provide at least in part an alternate approach to procedure 500 in FIG. 5. The communication system for the example procedure 600 may include a user/device 602, which may be a user using a device or a user behind the device, FESP 604, and TMF 606. Other network functions and devices, not shown, may be included. In this example, user/device 602, user 602, and device 602 may be used to refer to, respectively, the combination of the user and device, and the user and the device independently. User/device 602 may be a service consumer/FESC that requests to access target services provided by a service producer/FESP 602. FESP 604 may be service producer within a network (e.g., 5G or 6G network) or on a device. FESP 604 may be a service producer providing services to user/device 602 acting as a service consumer. The TMF 606 may provide services for evaluating, calculating, and exposing a trust index, such as a UTI, DTI, and/or the trust index of FESP 604. TMF 606 may be within the network (e.g., 5G or 6G network) or a third-party entity.

According to procedure 600, user/device 602 may control the exposure of its trust index(es) (i.e., UTI and DTI) and thus the user/device 602 may request that TMF 606 send UTI and DTI to FESP 604. Thus, FESP 604 may perform dynamic trust-based authentication by leveraging identifiers UTI and DTI. In the example procedure 600, it may be assumed that user/device 602 has discovered FESP 604 (e.g., from NRF or another repository function). With reference to FIGS. 5 and 6: request message 611 may be similar or equivalent to request message 511 in FIG. 5; response message 612 may be similar or equivalent to response message 512 in FIG. 5; authentication step 613 may be similar or equivalent to authentication step 513 in FIG. 5; service operation request message 614 may be similar or equivalent to service operation request message 514 in FIG. 5 (with the exception that TMFID may not be included in service operation request message 614); authentication step 615 may be similar or equivalent to authentication step 515 in FIG. 5; and trust level authentication step 616 may be similar or equivalent to trust level authentication step 516 in FIG. 5.

With reference to FIG. 6, FESP 604 may send a trust index request message 617 to the user/device 602 indicating that trust index of user/device 602 needs to be provided to FESP 604, so that FESP 604 can perform trust-based authentication of the service operation request 614. The trust index request message 617 may include parameter AddrForReceivingTI, which may indicate the address for receiving UTI and DTI from TMF 606 in notification message 620. User/device 602 may send a response message 618 to FESP 604 to inform FESP 604 that UTI and DTI will be sent to FESP 604 from TMF 606. The response message 618 may include UTI and DTI of the user/device 602. The response message 618 may include the identifier of TMF 606 (e.g., TMFID). User/device 602 may send a trust index request message 619 to TMF 606. The trust index request message 619 may contain any one or more of the following parameters: AddrForReceivingTI; the identifier of Device 602 (e.g., DevID); the identifier of user 602 (e.g., UserID); and ServiceID (similar to parameters of service operation request 614). Based on the received trust index request message 619, TMF 606 may recalculate UTI and/or DTI for user/device 602 for the purpose of accessing target services as denoted by ServiceID. Dependent on ServiceID, TMF 606 may calculate UTI and/or DTI differently. TMF 606 may generate a response and send the response in notification message 620 to AddrForReceivingTI (i.e., address of FESP 604). Notification message 620 may include any one or more of the following parameters: UserID, which may be the identifier of user 602; DevID, which may be the identifier of device 602; UTI, which may be the trust index of user 602; DTI, which may be the trust index of device 602; TMFID, which may be the identifier of TMF 606; and/or TMFCredential, which may be the credential of TMF606, based on which FESP 604 may authenticate TMF 606 in authentication step 621. Authentication step 621 may be similar or equivalent to authentication step 518 in FIG. 5. FESP 604 may receive notification message 620 and authenticate 621 TMF 606 based on the received parameter TMFCredential. With reference to FIGS. 5 and 6: authentication step 622 may be similar or equivalent to authentication step 522 in FIG. 5; authentication notification message 623 may be similar or equivalent to authentication notification message 523 in FIG. 5; authentication confirmation message 624 may be similar or equivalent to authentication confirmation message 524 in FIG. 5; execution of service operation step 625 may be similar or equivalent to execution of service operation step 525 in FIG. 5; and service operation response message 626 may be similar or equivalent to service operation response message 526 in FIG. 5.

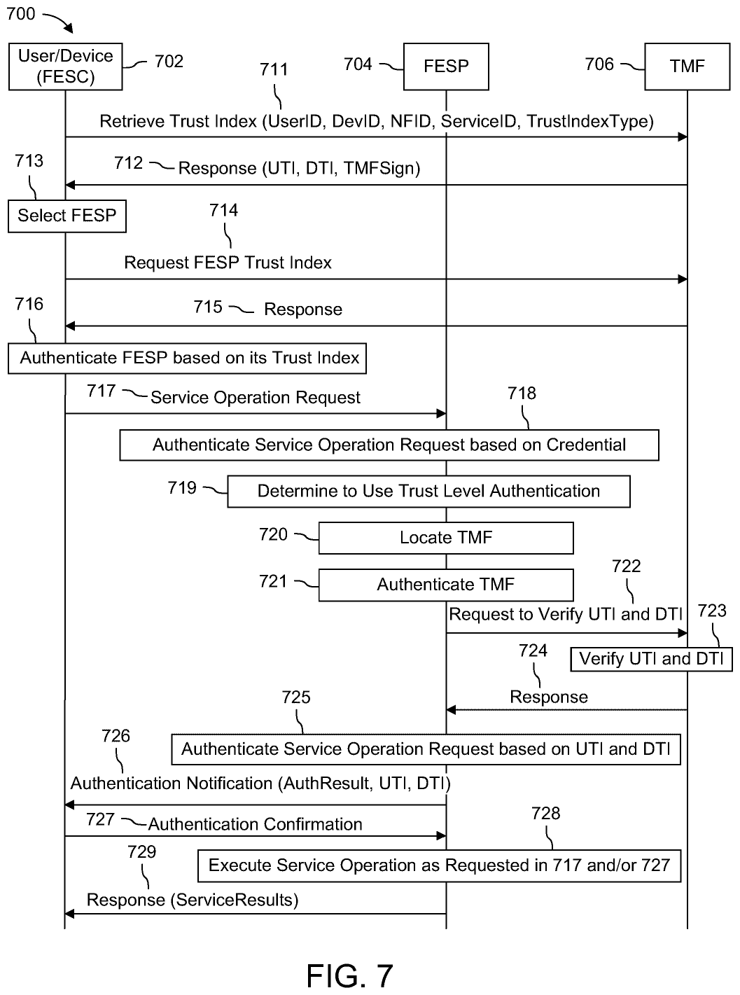

Another example procedure for dynamic trust-based authentication for request/response-based direct service interaction may involve FESC providing a trust index. FIG. 7 is a signaling diagram illustrating an example procedure 700 for dynamical trust-based authentication for request/response service interaction where a FESC 702 provides a trust index to a FESP 704. According to the example procedure 700, user/device 702 may know (e.g., from FESP service discovery) that UTI and DTI are needed to be reported to a FESP 704 in order to access target services from the FESP 704. As such, user/device 702 may first retrieve (step 711) its UTI and/or DTI from TMF 706. Then, user/device 702 may send its service operation request (step 717) for target services along with UTI and/or DTI to FESP 704. FESP 704 may verify UTI and/or DTI from TMF 706 and then perform trust-based authentication. For example procedure 700, it may be assumed that user/device 702 has discovered some FESPs (e.g., from NRF or another repository function).

The example procedure 700 illustrated in FIG. 7 may provide at least in part an alternate approach to procedure 500 in FIG. 5 and procedure 600 in FIG. 6. The communication system for the example procedure 700 may include a user/device 702, which may be a user using a device or a user behind the device, FESP 704, and TMF 706. Other network functions and devices, not shown, may be included. In this example, user/device 702, user 702, and device 702 may be used to refer to, respectively, the combination of the user and device, and the user and the device independently. User/device 702 may be a service consumer/FESC that requests to access target services provided by a service producer/FESP 704. FESP 704 may be service producer within a network (e.g., 5G or 6G network) or on a device. FESP 704 may be a service producer providing services to user/device 702 acting as a service consumer. The TMF 706 may provide services for evaluating, calculating, and exposing a trust index, such as a UTI, DTI, and/or the trust index of FESP 704. TMF 706 may be within the network (e.g., 5G or 6G network) or a third-party entity. The detailed steps of procedure 700 are described hereinafter.

User/device 702 may send a trust index retrieval request message 711 to TMF 706. It may be assumed that user/device 702 have been provisioned with or have discovered TMF 706. The trust index retrieval request message 711 may contain any one or more of the following parameters: UserID; DevID; FESPID, which may be the identifier of FESP 704 the retrieved UTI and/or DTI will be sent to; NFID, which may be an identifier of a network function; ServiceID, which may be the identifier or the type of target services that UTI and/or DTI will be used for authentication for; TrustIndexType, which may indicate the type of trust index this request 711 needs to retrieve (e.g., user trust index, and device trust index); and/or TINotifCriteria, which may be used by user/device 702 to request TMF 706 to send trust index notifications according to the criteria or conditions contained in this parameter. For example, one criterion of TINotifCriteria may be “send new trust index after a period of time such as 10 minutes” or “send new trust index if it falls above, below, or outside a threshold”. By including TINotifCriteria in request 711, TMF 706 can actively push UTI and DTI to user/device 702 without requiring user/device 702 to send additional requests to TMF 706. TINotifCriteria may also include the identifier or the address of user/device 702 to receive trust index notifications from TMF 706. Trust index retrieval request message 711 may include TrustIndexMode, TrustIndexTimeWindow and any one or more of the parameters described in request message 611 in FIG. 6.

With reference to FIG. 7, TMF 706 may look up or recalculate needed trust index as indicated by TrustIndex Type and other parameters (e.g., TrustIndexMode) for user/device 702 (e.g., UTI and DTI in this case). Then, TMF 706 may sign the calculated UTI and DTI along with a few other parameters (e.g., when UTI and DTI were calculated, how long UTI and DTI can be valid) and generate its signature (i.e., TMFSign). TMF 706 may create and send a response message 712 to user/device 702. The response message 712 may include any one or more of the following parameters: TIIE may be an information element of trust index; and/or TMFSign, which may be the signature that TMF 706 generated over TIIE. Parameter TIIE may include any one or more of the following sub-parameters: UTI, which may be the calculated trust index of user 702; DTI, which may be the calculated trust index of device 702; UTICreationTime, which may be an indication of time instance or period when UTI was last calculated; DTICreationTime, which may be the time instance or period when DTI was last calculated; UTIValidTime, which may be the absolute time duration or relative time duration that UTI will be valid; and/or DTIValidTime, which may be the absolute time duration or relative time duration that DTI will be valid.

User/device 702 may perform FESP (re-) selection (e.g., using request message 714) to select an appropriate FESP for its target services according to the received UTI and DTI, assuming user/device knows of multiple FESPs (e.g., via previsioning or discovery). For example, if the value of UTI and/or DTI is not high (i.e., below threshold(s)), user/device 702 may select FESP 704 that does not have strict requirements on trust index. In another example, if the value of UTI and/or DTI is high enough (e.g., above threshold(s)), user/device 702 may select FESP 704 considering other factors with a precedence over trust index. With reference to FIGS. 5 and 7: request message 714 may be similar or equivalent to request message 511 in FIG. 5; and response message 715 may be similar or equivalent to response message 512 in FIG. 5. As an alternative to request message 714 and response message 715 not shown, user/device 702 may use request message 714 to subscribe to some changes of FESP's 704 trust index (e.g., when FESP's 704 trust index is below a threshold and/or above another threshold). In this case, request message 714 may include notification criteria on FESP's 704 trust index. An example criterion may be “FESP's trust index is below a specific threshold”. Then, TMF 706 may generate automatic notifications about FESP's 704 current trust index when it meets notification criteria. Such notifications on FESP's 704 current trust index may be repeatedly sent from TMF 706 to FESC 702. After receiving a notification from TMF 706, FESC 702 may (re) perform authentication step 716.

With reference to FIGS. 5 and 7: authentication step 716 may be similar or equivalent to authentication step 513 in FIG. 5. Similar to request message 511, response message 512 and authentication step 513 in FIG. 5, request message 714 and response message 715 may be performed for user/device 702 to query or retrieve or subscribe to trust index of the selected FESP 704 from TMF 706 and authenticate the selected FESP 704 based on its trust index. With reference to FIGS. 5 and 7: service operation request message 717 may be similar or equivalent to service operation request message 514 in FIG. 5. Service operation request message 717 may further include parameters TIIE and/or TMFSign, as received in response message 712. With reference to FIGS. 5 and 7: authentication step 718 may be similar or equivalent to service authentication step 515 in FIG. 5; trust level authentication step 719 may be similar or equivalent to trust level authentication step 516 in FIG. 5; TMF selection step 720 may be similar or equivalent to TMF selection step 517 in FIG. 5; and TMF authentication step 721 may be similar or equivalent to TMF authentication step 518 in FIG. 5. As part of TMF authentication step 721, FESP 704 may verify if TMFSign is valid, for instance, using TMF public key. If FESP 704 is able to verify TMFSign, TIIE may be a valid information element from TMF 706. In this case, request message 722, UTI and DTI verification step 723, and response message 724 may be skipped. If FESP 704 cannot verify TMFSign and TIIE (e.g., TMFSign was not included in response message 712), then FESP 704 may interact with TMF 706 directly to verify TIIE, for example using request message 722, UTI and DTI verification step 723, and response message 724.

FESP 704 may send a trust index verification request message 722 to TMF 706. The trust index verification request message 722 may include TIIE as received in service operation request 717. TMF 706 at verification step 723 may verify if the information included in TIIE is correct. TMF 706 may send a response message 724 to FESP 704 indicating if TIIE is valid or not. With reference to FIGS. 5 and 7: authentication step 725 may be similar or equivalent to authentication step 522 in FIG. 5; authentication notification message 726 may be similar or equivalent to authentication notification message 523 in FIG. 5; authentication confirmation message 727 may be similar or equivalent to authentication confirmation message 524 in FIG. 5; service operation execution step 728 may be similar or equivalent to service operation execution step 525 in FIG. 5; and response message 729 may be similar or equivalent to response message 526 in FIG. 5.

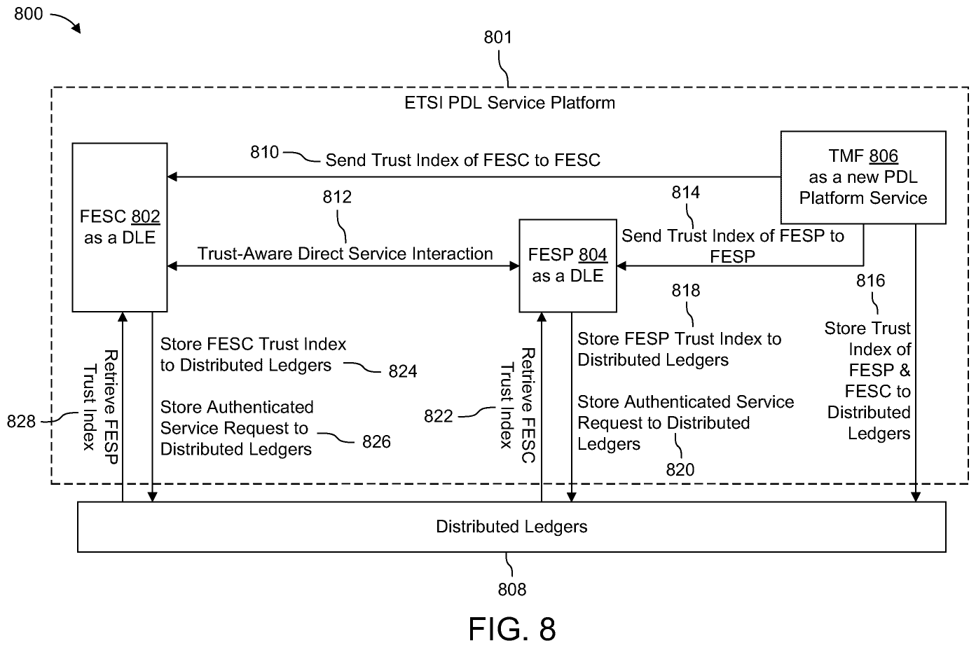

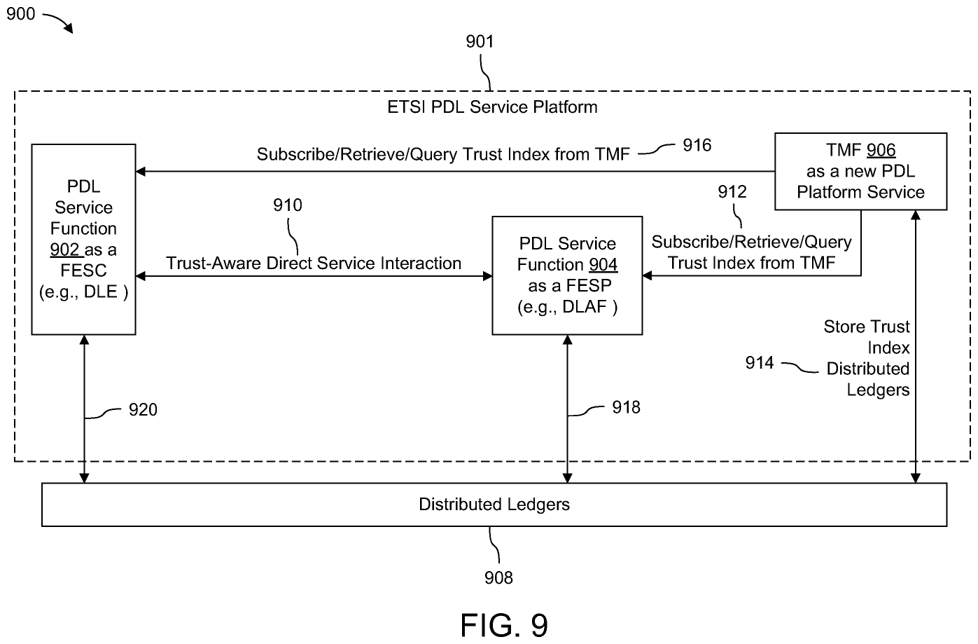

Procedures and approaches disclosed herein may be implemented for example using a Permissioned Distributed Ledgers (PDL) architecture, examples of which are given in FIGS. 8 and 9. FIG. 8 is a signaling diagram illustrating an example procedure 800 for dynamic trust-based authentication for request/response service interaction. The communication system for the example procedure 800 may include, within an ETSI PDL Service Platform 801: FESC 802 as a Distributed Ledger Enabler (DLE); FESP 804 as a DLE; and TMF 806 as a new PDL platform service. The communication system for the example procedure 800 may further include distributed ledgers 808. FESC 802 may be implemented as a DLE node such as a DLE-client. Alternatively, FESC 802 may have an embedded DLE or interact with an external DLE. FESC 802 may leverage DLE to interface to a PDL service platform 801. FESP 804 may be implemented as a DLE node such as a DLE-Peer. Alternatively, FESC 802 may have an embedded DLE or interact with an external DLE; FESC 802 may leverage DLE to interface to a PDL service platform 801. TMF 806 can be implemented as a new PDL platform service, which may be accessed by FESC 802 (as a DLE) and FESP 804 (as a DLE). TMF 806 may record or store, at step 816, the calculated trust index of FESCs 802 and FESPs 804 including TMF's 806 signature to one or more distributed ledgers 808. Alternatively, a FESC 802 may retrieve its trust index, provided via trust index message 810 from TMF 806, and then store, at step 824, its trust index to one or more distributed ledgers 808. Similarly, a FESP 804 may retrieve its trust index, provided via trust index message 814 from TMF 806, and then store, at step 818, its trust index to one or more distributed ledgers 808. In an example, FESC 802 and/or FESP 804 may retrieve its trust index directly from one or more distributed ledgers 808.

When authenticating a service operation request from a FESC 802, a FESP 804 may retrieve, in step 822, the trust index of a FESC 802 from one or more distributed ledgers 808 (or TMF 806). The FESP 804 may subscribe to one or more distributed ledgers 808 (e.g., via a DLE-Peer) to receive automatic notifications 822 about FESC's trust index from the distributed ledgers 808. After the service operation request is successfully authenticated considering trust index, the FESP 804 may record or store, at step 820, the request and/or corresponding service results to one or more distributed ledgers 808. When authenticating a FESP 804, a FESC 802 may retrieve, in step 828, the trust index of FESP 804 from one or more distributed ledgers 808 (or TMF 806). The FESP 804 may subscribe to one or more distributed ledgers 808 (e.g., via a DLE-Peer) to receive automatic notifications, 822, about FESP's 804 trust index from the distributed ledgers 808. After the FESP 804 is successfully authenticated considering its trust index, the FESC 802 may record or store, at step 826, the request and/or corresponding service results to one or more distributed ledgers 808. The FESC 802 and FESP 804 may use the procedures 500/600/700 described in FIGS. 5, FIG. 6, and/or FIG. 7 to perform trust-aware direct service interaction 812.

FIG. 9 is a signaling diagram illustrating another example procedure 900 for dynamic trust-based authentication for request/response service interaction. The communication system for the example procedure 900 may include, within an ETSI PDL Service Platform 901: PDL service function as a FESC 902 (e.g., DLE); PDL service function as a FESP 904 (e.g., Distributed Ledger Anchor Function (DLAF)); and TMF 906 as a new PDL platform service. The communication system for the example procedure 900 may further include distributed ledgers 908. FESC 902 may be implemented as a DLE node such as a DLE-client. Alternatively, FESC 902 may have an embedded DLE or interact with an external DLE. FESC 902 may leverage DLE to interface to a PDL service platform 901. FESP 904 may be implemented as a DLE node such as a DLE-Peer. Alternatively, FESC 902 may have an embedded DLE or interact with an external DLE. FESC 902 may leverage DLE to interface to a PDL service platform 801. TMF 906 can be implemented as a new PDL platform service, which may be accessed by FESC 902 (as a DLE) and FESP 904 (as a DLE). FESC 902 may subscribe/retrieve/query, in step 916, its trust index or the trust index of FESP 904 from TMF 906. FESP 904 may subscribe/retrieve/query, in step 912, its trust index or the trust index of FESC 902 from TMF 906. TMF 906 may record or store, at step 914, the calculated trust index of FESC 902 and/or FESP 904 including TMF's 906 signature to one or more distributed ledgers 908. The PDL Service Function 902 as a FESC and the PDL Service Function 904 as a FESP may use the procedures 500/600/700 in FIG. 5, FIG. 6, and/or FIG. 7 to perform trust-aware direct service interaction 910. The PDL Service Function 904 as a FESP may interact 918 with one or more distributed ledgers 908 to store information to distributed ledgers 908 (e.g., to store the historical information of service interaction with the PDL Service Function 902 as a FESC) or retrieve information from distributed ledgers (e.g., to retrieve the trust index of the PDL Service Function 902 as a FESC). The PDL Service Function 902 as a FESC may interact 920 with one or more distributed ledgers 908 to store information to distributed ledgers 908 (e.g., to store the historical information of service interaction with the PDL Service Function 904 as a FESP) or retrieve information from distributed ledgers 908 (e.g., to retrieve the trust index of the PDL Service Function 904 as a FESP).

PDL service functions (e.g., DLE, DLAF, DLRF, Distributed Ledger Data Storage Management (DLDSM), and Distributed Ledger Governance Function (DLGF) may leverage the proposed procedures described herein to enhance their interaction with each other. When a PDL service function A requests/accesses/uses services provided by another PDL service function B, the PDL service function A may be a FESC while the PDL service function B may be a FESP. TMF is realized as a new PDL service function.

Trust covers security and goes beyond security. A trust index may be obtained via a trust evaluation process (e.g., conducted by a TMF). A trust index may be an overall metric, which may be calculated based on an aggregation of one or more trust indicators using certain trust evaluation algorithms. For example, trust indicators may cover various aspects, such as security, privacy, resilience, performance, robustness, scalability, availability, accuracy, reliability, and consistency. The criteria for evaluating trust may be subjective, for example based on user/personal experience/preference. For example, given two entities A and B (that need to interact with a third entity C), entities A and B may have different criteria regarding how the trust of entity C should be evaluated. For example, in the case where entities A and B are service consumers and entity C is a service producer, entity A and entity B may have different trust evaluation criteria regarding how to evaluate entity C's trust for providing various services. For example, entity A may prioritize security, privacy and resilience (e.g., as the focus of the trust indicators used in the trust index of entity C) of entity C when entity C is providing services to entity A. Entity B may prioritize a different set of trust indicators, such as availability and/or residency, of entity C when entity C is providing services to entity B. Therefore, the ideas and embodiments proposed herein may have any one or more of the following characteristics related to trust index. The following characteristics of the trust index may be applicable to all the proposed procedures and embodiments disclosed herein, for example, including any and all the messaging between an entity and a TMF.

In an example of trust index generation, when a requesting entity (e.g., entity A, which may be an FESP or FESC as defined herein) needs to contact a TMF (e.g. sending a request to a TMF) to inquire about a trust index of another target entity (e.g., entity C) or to initiate a trust evaluation on the target entity, the TMF may provide the trust index of the target entity (e.g., using procedures described hereinbefore) and return the trust index to the requesting entity (e.g., entity A) in a response message, and may further include associated explanatory information in the response message to the requesting entity. Associated explanatory information may indicate when the trust index was generated. For example, the trust index may be generated by a TMF an X time period prior (e.g., ten seconds prior), which may reflect the latest trust index of the target entity. In another example, associated explanatory information may indicate how the trust index was generated. For example, a parameter may indicate the next level of information regarding what kinds of trust evaluation criteria has been adopted by the TMF to generate this trust index. This parameter may indicate any of the following: what kinds of data were collected for trust evaluation and where the data were stored; what kinds of trust indicators were focused; what kinds of algorithms were adopted for calculating trust indicators and/or the trust index (e.g., during the trust evaluation, what kinds of collected data were used as inputs for the adopted algorithms in order to calculate the focused trust indicators and/or the overall trust index); and/or what kinds of parameter values were set during the calculation of trust indicators or a trust index. A TMF may be preconfigured with a popular or standard suite of trust evaluation criteria, so that the TMF may conduct a trust evaluation technique may be, for example, appropriate or desired for most by one or more of the requesting entities. In another example, associated explanatory information may be the applicable scope of the trust index. It is possible that a target entity (e.g., entity C acting as a FESP) may provide different services, but the target entity may have different levels of trust when delivering those different services. For example, one service (e.g., Service X) provided by the target entity may be related to computing operations, while another service (e.g. Service Y) provided by the target entity may be related to communication operations. Therefore, it is possible that the target entity may have a high trust index for providing Service X, and at the same time, the FESP may have a low trust index for providing Service Y. Thus, when a TMF sends a trust index to a receiver or requesting entity (i.e. the entity A, who has sent a request to TMF for trust index inquiry or trust evaluation), any one or more of the above listed information elements may be included in the response message to the requesting entity along with the returned trust index value.

In another example of trust index generation, when a requesting entity (e.g., entity A) sends a request to a TMF to inquire about the trust index of a target entity (e.g., entity C), the request may further include parameters that enable customized trust evaluation by describing how the requesting entity (e.g., entity A) prefers the TMF to conduct trust evaluation on the target entity, and/or how the trust index shall or should be calculated or determined. For example, in addition to whose trust index is being requested (e.g. entity C), any one or more of the following information elements related to customized trust evaluation criteria may also be included in the request sent from the requesting entity to the TMF. Information related to customized trust evaluation criteria may include how the trust of the target entity should be evaluated (e.g., what kinds of specific trust evaluation criteria should be adopted by TMF to generate a trust index). Information on how the trust of the target entity should be evaluated may include any one or more of the following information: what kinds of trust indicators should be focused; what kinds of algorithms should be adopted for calculating trust indicators; and/or the trust index. In an example, a TMF may be pre-provisioned with different sets of trust evaluation criteria (each may be identified by a trust evaluation criteria identifier). In this case, the requesting entity (entity A) may directly indicate the identifier of the preferred trust evaluation criteria when it sends the trust index inquiry request to the TMF. In response to receiving a parameter indicating the identifier of the preferred trust evaluation criteria, the TMF may adopt the corresponding trust evaluation criteria preferred by the entity A when the TMF conducts a trust evaluation on the target entity (entity C) in order to generate the trust index of the target entity. Information related to customized trust evaluation criteria may include the applicable scope of the trust index. The target entity (entity C) may provide different services, but the target entity may have different levels of trust when delivering those different services. For example, one service (e.g., Service X) provided by the target entity may be related to computing operations, while another service (e.g., Service Y) provided by the target entity may be related to communication operations. Therefore, the parameter directed to the applicable scope of the trust index may indicate that entity A intends to inquire about the trust index of the target entity (entity C) regarding which services. For example, entity A may only want to know the trust of target entity for providing a specific service (e.g., Service X). In another example, entity A may want to know the trust of a target entity for providing a set of specific services (e.g., Service X and Service Y) or all of the services provided by the target entity. Thus, the parameter directed to the applicable scope of the trust index allows the TMF to determine which data shall be collected in order to calculate the requested trust index. Information related to customized trust evaluation criteria may indicate that TMF may conduct the customized trust evaluation based on any one or more of the above parameters sent from entity A. Once a trust index is generated by the TMF, the TMF will send the trust index to entity A. Thus, when a TMF sends a trust index to a receiver or requesting entity (i.e. the entity A, who has sent a request to TMF for trust index inquiry or trust evaluation), the TMF may provide the trust index value of the target entity (e.g., a numerical value or a rank) and/or a set of explanatory information, which are the same as the parameters listed in the previous example of trust index generalization, such as when the trust index was generated, how the trust index was generated (e.g., the adopted trust evaluation criteria), and the applicable scope of the trust index.

The embodiments described herein may involve steps or actions related to a requesting entity interacting with a TMF, such as “sending” a request to a TMF for inquiring regarding the trust index of a target entity and “receiving” a response from a TMF, in which the inquired trust index is attached or included. Such an interaction may be further generalized to “obtaining” the trust index of a target entity from the TMF. In other words, depending on how the TMF is implemented, “obtaining” the trust index of a target entity may be realized in different ways. For example, the requesting entity may communicate with the TMF via an intermediate medium, such as a distributed ledger. In another example, the TMF may be implemented in different ways. For example, the TMF may be implemented as a native 3GPP function (e.g. as a new Network Function (NF) in the core network, a new function inside the access network of the 3GPP system, or implemented as an enhanced feature of an existing NF in 3GPP cellular system, such as 5G network data analytics function (NWDAF) and/or the Security Function deployed by the MNO). The TMF may also be implemented as a new ETSI PDL platform service, or as a smart contract deployed in a distributed ledger system (in this case, the request/response may be embodied as distributed ledger transactions).

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method performed by a service consumer associated with a user and a device that is a wireless transmit/receive unit (WTRU), the method comprising:
sending, to a service producer, a service operation request message requesting access to at least one target service provided by the service producer, wherein the service operation request message includes a first indication indicating that the user and the device will authenticate and authorize the service producer using a trust index of the service producer and a second indication indicating that the user and the device support or request to be authenticated and authorized by the service producer using at least one of: a user trust index (UTI) of the user and a device trust index (DTI) of the device;
receiving, from the service producer, an authentication notification message including an indication of a trust-based authentication result indicating that the service producer will execute the at least one target service;
sending, to the service producer, an authentication confirmation message; and
receiving, from the service producer, a service operation response message including at least one service execution result associated with the executed at least one target service.

2. The method of claim 1, further comprising:
sending, to a trust management function (TMF), a request message indicating a request for the trust index of the service producer; and
receiving, from the TMF, a response message indicating the trust index of the service producer, wherein the service consumer authenticates the service producer by comparing the trust index of the service producer to a preconfigured threshold, and wherein the service consumer sends the service operation request message only if the authentication is successful.

3. The method of claim 1, wherein a trust index is a metric that indicates a level of trustworthiness and is based on a trust evaluation of one or more trust indicators.

4. The method of claim 3, wherein the trust indicators comprise factors related to at least one of: security, privacy, resilience, performance, robustness, scalability, availability, accuracy, reliability, or consistency.

5. The method of claim 1, wherein the service operation request message further includes at least one of: an identifier of the device; an identifier of the user; a credential of the user; at least one identifier of the at least one target service; an indication of a type of service operation being requested; an identifier of a trust management function (TMF); an indication of an address for receiving the authentication notification message; a credential for the TMF; an indication requesting the service producer to provide the UTI of the user and the DTI of the device; an indication of a mode of a requested trust index; and an indication of a trust index time window.

6. The method of claim 1, wherein the authentication notification message further comprises at least one of: the UTI of the user; the DTI of the device; a UTI threshold; a DTI threshold; and a common trust index threshold.

7. The method of claim 1, further comprising:
forwarding the at least one service execution result to at least one of: an application server; a next application function in a chain of application functions; and a charging function.

8. The method of claim 1, wherein the service consumer is a Function Entity Service Consumer (FESC) and the service producer is a Function Entity Service Producer (FESP).

9. A service consumer comprising a device that is a wireless transmit/receive unit (WTRU) and associated with a user, the service consumer comprising:
a transceiver; and
a processor, wherein the transceiver and the processor are configured to:
send, to a service producer, a service operation request message requesting access to at least one target service provided by the service producer, wherein the service operation request message includes a first indication indicating that the user and the device will authenticate and authorize the service producer using a trust index of the service producer and a second indication indicating that the user and the device support or request to be authenticated and authorized by the service producer using at least one of: a user trust index (UTI) of the user and a device trust index (DTI) of the device;
receive, from the service producer, an authentication notification message including an indication of a trust-based authentication result indicating that the service producer will execute the at least one target service;
send, to the service producer, an authentication confirmation message; and
receive, from the service producer, a service operation response message including at least one service execution result associated with the executed at least one target service.

10. The service consumer of claim 9, wherein the transceiver and the processor are further configured to:
send, to a trust management function (TMF), a request message indicating a request for the trust index of the service producer; and
receive, from the TMF, a response message indicating the trust index of the service producer, wherein the service consumer authenticates the service producer by comparing the trust index of the service producer to a preconfigured threshold, and wherein the service consumer sends the service operation request message only if the authentication is successful.

11. The service consumer of claim 9, wherein a trust index is a metric that indicates a level of trustworthiness and is based on a trust evaluation of one or more trust indicators.

12. The service consumer of claim 11, wherein the trust indicators comprise factors related to at least one of: security, privacy, resilience, performance, robustness, scalability, availability, accuracy, reliability, or consistency.

13. The service consumer of claim 9, wherein the service operation request message further includes at least one of:
an identifier of the device; an identifier of the user; a credential of the user; at least one identifier of the at least one target service; an indication of a type of service operation being requested; an identifier of a trust management function (TMF);
an indication of an address for receiving the authentication notification message; a credential for the TMF; an indication requesting the service producer to provide the UTI of the user and the DTI of the device; an indication of a mode of a requested trust index; and an indication of a trust index time window.

14. The service consumer of claim 9, wherein the authentication notification message further comprises at least one of: the UTI of the user; the DTI of the device; a UTI threshold; a DTI threshold; and a common trust index threshold.

15. The service consumer of claim 9, wherein the transceiver and the processor are further configured to:
forward the at least one service execution result to at least one of: an application server; a next application function in a chain of application functions; and a charging function.

16. The service consumer of claim 9, wherein the service consumer is a Function Entity Service Consumer (FESC) and the service producer is a Function Entity Service Producer (FESP).

17. A method performed by a service producer comprising:
receiving, from a service consumer, a service operation request message requesting access to at least one target service provided by the service producer, wherein the service operation request message includes a first indication indicating that a user associated with the service consumer and a device associated with the service consumer will authenticate and authorize the service producer using a trust index of the service producer and a second indication indicating that the user and the device support or request to be authenticated and authorized by the service producer using at least one of: a user trust index (UTI) of the user and a device trust index (DTI) of the device;
determining that a trust level authentication of the user associated with the service consumer or a device associated with the service consumer is needed;
selecting and authenticating a trust management function (TMF);
sending, to the selected and authenticated TMF, a request message requesting at least one of the UTI of the user and the DTI of the device;
receiving, from the selected and authenticated TMF, a response message including an indication of at least one of the UTI of the user and the DTI of the device;
authenticating the received service operation request message using trust-based authentication based on the at least one of the UTI of the user and the DTI of the device;
sending, to the service consumer, an authentication notification message including an indication of a result of the trust-based authentication indicating that the service producer will execute the at least one target service;
receiving, from the service consumer, an authentication confirmation message;
executing the at least one target service; and
sending, to the service consumer, a service operation response message including at least one service execution result associated with the executed at least one target service.

18. The method of claim 17, further comprising authenticating the received service operation request message based on a credential of the user in addition to the trust-based authentication.

19. The method of claim 17, wherein the authenticating the received service operation request message using trust-based authentication includes comparing the UTI to a UTI threshold and comparing the DTI to a DTI threshold.

20. The method of claim 17, wherein the service consumer is a Function Entity Service Consumer (FESC) and the service producer is a Function Entity Service Producer (FESP).
